(19) United States
(12) Patent Application Publication
(10) Pub. No.: US 2025/0311046 A1
(43) Pub. Date: Oct. 2, 2025

(54) PROTOCOL DATA UNIT SET IMPORTANCE-BASED DISCARD IN DUAL CONNECTIVITY

(71) Applicant: QUALCOMM Incorporated, San Diego, CA (US)

(72) Inventors: Mickaël MONDET, Louannec (FR); Prasada Veera Reddy KADIRI, San Diego, CA (US); Linhai HE, San Diego, CA (US); Diana MAAMARI, San Diego, CA (US); Hyun Yong LEE, San Diego, CA (US)

(21) Appl. No.: 19/094,452

(22) Filed: Mar. 28, 2025

Related U.S. Application Data
(60) Provisional application No. 63/573,368, filed on Apr. 2, 2024.

(51) Int. Cl. H04W 76/27; H04L 47/32; H04W 28/06; H04W 72/231; H04W 88/08

(52) U.S. Cl. CPC H04W 76/27; H04L 47/32; H04W 28/06; H04W 72/231; H04W 88/085

(57) ABSTRACT

Methods, systems, and devices for wireless communications are described. A first network entity may communicate with a user equipment (UE) via a split data radio bearer (DRB) deployment that supports a protocol data unit (PDU) set importance (PSI)-based discard procedure for dual connectivity. The first network entity may communicate, via one or more interfaces with a second network entity involved in the dual connectivity, one or more messages that include an indication of at least one state change of the PSI-based discard procedure, which may include either an activation of the PSI-based discard procedure or a deactivation of the PSI-based discard procedure. The first network entity, the second network entity, or both, may communicate an indication of the at least one state change of the PSI-based discard procedure with the UE to coordinate the state change.

### CROSS REFERENCE

The present Application for Patent claims benefit of U.S. Provisional Patent Application No. 63/573,368 by Mondet et al., entitled “Protocol Data Unit Set Importance-Based Discard in Dual Connectivity,” filed Apr. 2, 2024, assigned to the assignee hereof, and expressly incorporated herein.

### FIELD OF TECHNOLOGY

The following relates to wireless communications, including protocol data unit (PDU) set importance (PSI)-based discard in dual connectivity.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support protocol data unit (PDU) set importance (PSI)-based discard in dual connectivity. For example, the described techniques provide for coordination for changes in an activation or deactivation state of the PSI-based discard procedure. For example, a first network entity may communicate with a user equipment (UE) via a split data radio bearer (DRB) deployment that supports the PSI-based discard procedure for dual connectivity. The first network entity may communicate, via one or more interfaces with a second network entity involved in the dual connectivity, one or more messages that include an indication of at least one state change of the PSI-based discard procedure, which may include either the activation of the PSI-based discard procedure or the deactivation of the PSI-based discard procedure. The first network entity, the second network entity, or both, may communicate an indication of the at least one state change of the PSI-based discard procedure with the UE to coordinate the state change. For example, the UE may implement the activation or deactivation of the PSI-based discard procedure based on receiving one or more medium access control-control elements (MAC-CEs) from the first and second network entities.

A method for wireless communications by a first network entity is described. The method may include communicating with a UE via a split DRB deployment that supports a PSI-based discard procedure for dual connectivity, communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure, and communicating with the UE in accordance with the indication of the at least one state change of the PSI-based discard procedure.

A first network entity for wireless communications is described. The first network entity may include one or more memories storing processor executable code, and one or more processors coupled with the one or more memories. The one or more processors may individually or collectively be operable to execute the code to cause the first network entity to communicate with a UE via a split DRB deployment that supports a PSI-based discard procedure for dual connectivity, communicate, via one or more interfaces, one or more messages that include an indication of at least one state change of the PSI-based discard procedure, where the at least one state change of the PSI-based discard procedure includes activating the PSI-based discard procedure or deactivating the PSI-based discard procedure, and communicate with the UE in accordance with the indication of the at least one state change of the PSI-based discard procedure.

Another first network entity for wireless communications is described. The first network entity may include means for communicating with a UE via a split DRB deployment that supports a PSI-based discard procedure for dual connectivity, means for communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure, and means for communicating with the UE in accordance with the indication of the at least one state change of the PSI-based discard procedure.

A non-transitory computer-readable medium storing code for wireless communications is described. The code may include instructions executable by one or more processors to communicate with a UE via a split DRB deployment that supports a PSI-based discard procedure for dual connectivity, communicate, via one or more interfaces, one or more messages that include an indication of at least one state change of the PSI-based discard procedure, where the at least one state change of the PSI-based discard procedure includes activating the PSI-based discard procedure or deactivating the PSI-based discard procedure, and communicate with the UE in accordance with the indication of the at least one state change of the PSI-based discard procedure.

In some examples of the method, first network entities, and non-transitory computer-readable medium described herein, the one or more messages further include a request for acceptance or rejection of the at least one state change of the PSI-based discard procedure and the method, apparatuses, and non-transitory computer-readable medium may include further operations, features, means, or instructions for obtaining a first message indicating the acceptance or rejection of the at least one state change of the PSI-based discard procedure.

In some examples of the method, first network entities, and non-transitory computer-readable medium described herein, the first network entity communicates the one or more messages that include the indication of the at least one state change of the PSI-based discard procedure prior to implementing the at least one state change of the PSI-based discard procedure.

In some examples of the method, first network entities, and non-transitory computer-readable medium described herein, communicating the one or more messages may include operations, features, means, or instructions for communicating one or more PSI-based discard procedure update request messages and one or more PSI-based discard procedure update response messages via an Xn interface between a first CU of the first network entity and a second centralized unit (CU) of the second network entity, where the one or more PSI-based discard procedure update request messages and the one or more PSI-based discard procedure update response messages may be communicated via at least one of a secondary node modification request message, a secondary node modification required message, a secondary node modification request acknowledge message, or a secondary node modification confirm message.

In some examples of the method, first network entities, and non-transitory computer-readable medium described herein, the secondary node modification request message, the secondary node modification required message, or both, include a PSI-based discard procedure state request information element for each DRB of the split DRB deployment.

In some examples of the method, first network entities, and non-transitory computer-readable medium described herein, the PSI-based discard procedure may be deactivated based on the PSI-based discard procedure state request information element having a first bit value, and the PSI-based discard procedure may be activated based on the PSI-based discard procedure state request information element having a second bit value different from the first bit value.

In some examples of the method, first network entities, and non-transitory computer-readable medium described herein, the secondary node modification request acknowledge message, the secondary node modification confirm message, or both, include a PSI-based discard procedure state response information element for each DRB of the split DRB deployment.

In some examples of the method, first network entities, and non-transitory computer-readable medium described herein, the PSI-based discard procedure state response information element includes at least one response bit from a second network entity and a first response bit value indicates that the at least one state change of the PSI-based discard procedure may be denied, and a second response bit value different from the first response bit value indicates that the at least one state change of the PSI-based discard procedure may be accepted.

In some examples of the method, first network entities, and non-transitory computer-readable medium described herein, the PSI-based discard procedure state response information element includes at least one response bit from the second network entity and a first response bit value indicates a request to implement a deactivation of the PSI-based discard procedure, and a second response bit value different from the first response bit value indicates a request to implement an activation of the PSI-based discard procedure.

In some examples of the method, first network entities, and non-transitory computer-readable medium described herein, the secondary node modification request message, the secondary node modification required message, or both, include a PSI-based discard procedure MAC-CE request information element that may be indicative of a MAC-CE that the first network entity requests to output to the UE.

In some examples of the method, first network entities, and non-transitory computer-readable medium described herein, the secondary node modification request message, the secondary node modification confirm message, or both, include a PSI-based discard procedure MAC-CE response information element that may be indicative of a MAC-CE that includes feedback information for the PSI-based discard procedure from a second network entity.

In some examples of the method, first network entities, and non-transitory computer-readable medium described herein, communicating the one or more messages may include operations, features, means, or instructions for communicating one or more PSI-based discard procedure update request messages and one or more PSI-based discard procedure update response messages via an Xn interface between a first CU of the first network entity and a second CU of a second network entity, where the one or more PSI-based discard procedure update request messages and the one or more PSI-based discard procedure update response messages may be communicated via at least one of a secondary node PSI-based discard procedure update request message, a secondary node PSI-based discard procedure update required message, a secondary node PSI-based discard procedure update request acknowledge message, or a secondary node PSI-based discard procedure update confirm message.

In some examples of the method, first network entities, and non-transitory computer-readable medium described herein, the secondary node PSI-based discard procedure update request message, the secondary node PSI-based discard procedure update required message, or both, include a PSI-based discard procedure state request information element or in a PSI-based discard procedure MAC-CE request information element.

In some examples of the method, first network entities, and non-transitory computer-readable medium described herein, the secondary node PSI-based discard procedure update request acknowledge message, the secondary node PSI-based discard procedure update confirm message, or both, include a PSI-based discard procedure state response information element or in a PSI-based discard procedure MAC-CE response information element.

In some examples of the method, first network entities, and non-transitory computer-readable medium described herein, communicating the one or more messages may include operations, features, means, or instructions for communicating one or more PSI-based discard procedure update response messages via an Xn interface between a first CU of the first network entity and a second CU of a second network entity, where the one or more PSI-based discard procedure update response messages may be communicated via a secondary node PSI-based discard procedure update request reject message, a secondary node PSI-based discard procedure update refuse message, or both.

In some examples of the method, first network entities, and non-transitory computer-readable medium described herein, communicating the one or more messages may include operations, features, means, or instructions for communicating one or more PSI-based discard procedure update request messages and one or more PSI-based discard procedure update response messages via an F1 interface between a first distributed unit (DU) of the first network entity and a first CU of the first network entity, where the one or more one or more PSI-based discard procedure update request messages and the one or more PSI-based discard procedure update response messages may be communicated via at least one of a UE context modification request message, a UE context modification required message, a UE context modification response message, or a UE context modification confirm message.

In some examples of the method, first network entities, and non-transitory computer-readable medium described herein, the UE context modification request message, the UE context modification required message, or both, include a PSI-based discard procedure state request information element for each DRB of the split DRB deployment.

In some examples of the method, first network entities, and non-transitory computer-readable medium described herein, the PSI-based discard procedure may be deactivated based on the PSI-based discard procedure state request information element having a first bit value, and the PSI-based discard procedure may be activated based on the PSI-based discard procedure state request information element having a second bit value different from the first bit value.

In some examples of the method, first network entities, and non-transitory computer-readable medium described herein, the UE context modification response message, the UE context modification confirm message, or both, include a PSI-based discard procedure state response information element for each DRB of the split DRB deployment.

In some examples of the method, first network entities, and non-transitory computer-readable medium described herein, the PSI-based discard procedure state response information element includes at least one response bit and a first response bit value indicates that the at least one state change of the PSI-based discard procedure may be denied, and a second response bit value different from the first response bit value indicates that the at least one state change of the PSI-based discard procedure may be accepted.

In some examples of the method, first network entities, and non-transitory computer-readable medium described herein, the PSI-based discard procedure state response information element includes at least one response bit and a first response bit value indicates a request to implement a deactivation of the PSI-based discard procedure, and a second response bit value different from the first response bit value indicates a request to implement an activation of the PSI-based discard procedure.

In some examples of the method, first network entities, and non-transitory computer-readable medium described herein, the UE context modification request message, the UE context modification required message, or both, include a PSI-based discard procedure MAC-CE request information element that may be indicative of a MAC-CE that the first network entity requests to output to the UE.

In some examples of the method, first network entities, and non-transitory computer-readable medium described herein, the UE context modification response message, the UE context modification confirm message, or both, include a PSI-based discard procedure MAC-CE response information element that may be indicative of a MAC-CE that includes feedback information for the PSI-based discard procedure from a second network entity.

In some examples of the method, first network entities, and non-transitory computer-readable medium described herein, communicating the one or more messages may include operations, features, means, or instructions for communicating one or more PSI-based discard procedure update request messages and one or more PSI-based discard procedure update response messages via an F1 interface between a first DU of the first network entity and a first CU of the first network entity, where the one or more PSI-based discard procedure update request messages and the one or more PSI-based discard procedure update response messages may be communicated via at least one of a UE PSI-based discard procedure update request message, a UE PSI-based discard procedure update required message, a UE PSI-based discard procedure update response message, or a UE PSI-based discard procedure update confirm message.

In some examples of the method, first network entities, and non-transitory computer-readable medium described herein, the UE PSI-based discard procedure update request message, the UE PSI-based discard procedure update required message, or both, include a PSI-based discard procedure state request information element or in a PSI-based discard procedure MAC-CE request information element.

In some examples of the method, first network entities, and non-transitory computer-readable medium described herein, the UE PSI-based discard procedure update response message, the UE PSI-based discard procedure update confirm message, or both, include a PSI-based discard procedure state response information element or in a PSI-based discard procedure MAC-CE response information element.

In some examples of the method, first network entities, and non-transitory computer-readable medium described herein, communicating the one or more messages may include operations, features, means, or instructions for communicating one or more PSI-based discard procedure update response messages via an F1 interface between a first DU of the first network entity and a first CU of the first network entity, where the one or more PSI-based discard procedure update response messages may be communicated via a UE PSI-based discard procedure update failure message, a UE PSI-based discard procedure update refuse message, or both.

Some examples of the method, first network entities, and non-transitory computer-readable medium described herein may further include operations, features, means, or instructions for communicating a capability message that indicates one or more capabilities of the first network entity, a second network entity, or both, to support coordination for the at least one state change of the PSI-based discard procedure prior to implementing the at least one state change of the PSI-based discard procedure.

In some examples of the method, first network entities, and non-transitory computer-readable medium described herein, the capability message may be communicated via an Xn interface via at least one of a secondary node addition request message, a secondary node addition request acknowledgment message, a secondary node modification request message, a secondary node modification request acknowledgment message, a secondary node modification required message, or a secondary node modification confirmation message.

In some examples of the method, first network entities, and non-transitory computer-readable medium described herein, the capability message may be communicated via an F1 interface via at least one of a UE context setup request message, a UE context setup response message, a UE context modification request message, a UE context modification response message, or a UE context modification required message, a UE context modification confirm message.

Some examples of the method, first network entities, and non-transitory computer-readable medium described herein may further include operations, features, means, or instructions for outputting a joint MAC-CE that may be indicative of an activation or deactivation status of the at least one state change of the PSI-based discard procedure for the first network entity, a second network entity, or both.

In some examples of the method, first network entities, and non-transitory computer-readable medium described herein, the joint MAC-CE includes a dual connectivity PSI-based discard procedure activation or deactivation MAC-CE.

In some examples of the method, first network entities, and non-transitory computer-readable medium described herein, the joint MAC-CE includes two octets, a first octet including a first activation or deactivation status of the first network entity and a second octet including a second activation or deactivation status of a second network entity.

In some examples of the method, first network entities, and non-transitory computer-readable medium described herein, communicating the one or more messages may include operations, features, means, or instructions for performing the at least one state change of the PSI-based discard procedure prior to communicating, with a second network entity, the one or more messages that include the indication of the at least one state change of the PSI-based discard procedure.

In some examples of the method, first network entities, and non-transitory computer-readable medium described herein, the one or more messages may be communicated via an Xn interface via a secondary node modification request message, a secondary node modification required message, or both.

In some examples of the method, first network entities, and non-transitory computer-readable medium described herein, the secondary node modification request message, the secondary node modification required message, or both, include a PSI-based discard procedure state request information element or in a PSI-based discard procedure MAC-CE request information element.

In some examples of the method, first network entities, and non-transitory computer-readable medium described herein, the one or more messages may be communicated via an Xn interface via a secondary node PSI-based discard procedure update notification message, a secondary node PSI-based discard procedure update notification required message, or both.

In some examples of the method, first network entities, and non-transitory computer-readable medium described herein, the secondary node PSI-based discard procedure update notification message, the secondary node PSI-based discard procedure update notification required message, or both, include a PSI-based discard procedure state request information element or in a PSI-based discard procedure MAC-CE request information element.

In some examples of the method, first network entities, and non-transitory computer-readable medium described herein, the one or more messages may be communicated via an F1 interface via a UE context modification request message, a UE context modification required message, or both.

In some examples of the method, first network entities, and non-transitory computer-readable medium described herein, the UE context modification request message, the UE context modification required message, or both, include a PSI-based discard procedure state request information element or in a PSI-based discard procedure MAC-CE request information element.

In some examples of the method, first network entities, and non-transitory computer-readable medium described herein, the one or more messages may be communicated via an F1 interface via a UE PSI-based discard procedure update notification message, a UE PSI-based discard procedure update notification required message, or both.

In some examples of the method, first network entities, and non-transitory computer-readable medium described herein, the UE PSI-based discard procedure update notification message, the UE PSI-based discard procedure update notification required message, or both, include a PSI-based discard procedure state request information element or in a PSI-based discard procedure MAC-CE request information element.

Some examples of the method, first network entities, and non-transitory computer-readable medium described herein may further include operations, features, means, or instructions for communicating a capability message that may be indicative of one or more capabilities of the first network entity, a second network entity, or both, to support coordination for the at least one state change of the PSI-based discard procedure after implementing the at least one state change of the PSI-based discard procedure.

In some examples of the method, first network entities, and non-transitory computer-readable medium described herein, the capability message may be communicated via an Xn interface via at least one of a secondary node addition request message, a secondary node addition request acknowledgment message, a secondary node modification request message, a secondary node modification request acknowledgment message, a secondary node modification required message, or a secondary node modification confirmation message.

In some examples of the method, first network entities, and non-transitory computer-readable medium described herein, the capability message may be communicated via an F1 interface via at least one of a UE context setup request message, a UE context setup response message, a UE context modification request message, a UE context modification response message, a UE context modification required message, or a UE context modification confirm message.

A method for wireless communications by a UE is described. The method may include communicating with a first network entity and a second network entity in accordance with a split DRB deployment that supports a PSI-based discard procedure for dual connectivity, receiving, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure, and communicating with the first network entity and the second network entity in accordance with the at least one state change of the PSI-based discard procedure.

A UE for wireless communications is described. The UE may include one or more memories storing processor executable code, and one or more processors coupled with the one or more memories. The one or more processors may individually or collectively be operable to execute the code to cause the UE to communicate with a first network entity and a second network entity in accordance with a split DRB deployment that supports a PSI-based discard procedure for dual connectivity, receive, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure, and communicate with the first network entity and the second network entity in accordance with the at least one state change of the PSI-based discard procedure.

Another UE for wireless communications is described. The UE may include means for communicating with a first network entity and a second network entity in accordance with a split DRB deployment that supports a PSI-based discard procedure for dual connectivity, means for receiving, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure, and means for communicating with the first network entity and the second network entity in accordance with the at least one state change of the PSI-based discard procedure.

A non-transitory computer-readable medium storing code for wireless communications is described. The code may include instructions executable by one or more processors to communicate with a first network entity and a second network entity in accordance with a split DRB deployment that supports a PSI-based discard procedure for dual connectivity, receive, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure, and communicate with the first network entity and the second network entity in accordance with the at least one state change of the PSI-based discard procedure.

In some examples of the method, UEs, and non-transitory computer-readable medium described herein, receiving the one or more respective messages may include operations, features, means, or instructions for receiving, from the first network entity, a first MAC-CE that indicates an activation or deactivation of the PSI-based discard procedure for the first network entity and receiving, from the second network entity, a second MAC-CE that indicates an activation or deactivation of the PSI-based discard procedure for the second network entity.

Some examples of the method, UEs, and non-transitory computer-readable medium described herein may further include operations, features, means, or instructions for discarding a first PDU set associated with a first DRB, where the first PDU set may be discarded based on the first MAC-CE indicating the activation of the PSI-based discard procedure for the first network entity and an expiration of a first timer while a second timer may be running and transmitting, to the second network entity, a second PDU set associated with the first DRB, where the second PDU set may be transmitted based on the second MAC-CE indicating the deactivation of the PSI-based discard procedure for the second network entity and the expiration of the first timer while the second timer may be running.

Some examples of the method, UEs, and non-transitory computer-readable medium described herein may further include operations, features, means, or instructions for transmitting, to the first network entity, a first PDU set associated with a first DRB, where the first PDU set may be transmitted based on the first MAC-CE indicating the deactivation of the PSI-based discard procedure for the first network entity and an expiration of a first timer while a second timer may be running and discarding a second PDU set associated with the first DRB, where the second PDU set may be discarded based on the second MAC-CE indicating the activation of the PSI-based discard procedure for the second network entity and the expiration of the first timer while the second timer may be running.

Some examples of the method, UEs, and non-transitory computer-readable medium described herein may further include operations, features, means, or instructions for transmitting, to the first network entity, a first PDU set associated with a first DRB, where the first PDU set may be transmitted based on the first MAC-CE indicating the deactivation of the PSI-based discard procedure for the first network entity and an expiration of a first timer while a second timer may be running and transmitting, to the second network entity, a second PDU set associated with the first DRB, where the second PDU set may be transmitted based on the second MAC-CE indicating the deactivation of the PSI-based discard procedure for the second network entity and the expiration of the first timer while the second timer may be running.

Some examples of the method, UEs, and non-transitory computer-readable medium described herein may further include operations, features, means, or instructions for discarding a first PDU set associated with a first DRB, where the first PDU set may be discarded based on the first MAC-CE indicating the activation of the PSI-based discard procedure for the first network entity and an expiration of a first timer while a second timer may be running and discarding a second PDU set associated with the first DRB, where the second PDU set may be discarded based on the second MAC-CE indicating the activation of the PSI-based discard procedure for the second network entity and the expiration of the first timer while the second timer may be running.

In some examples of the method, UEs, and non-transitory computer-readable medium described herein, the first MAC-CE and the second MAC-CE include at least one of PSI-based discard procedure activation MAC-CEs or PSI-based discard procedure deactivation MAC-CEs.

In some examples of the method, UEs, and non-transitory computer-readable medium described herein, the first MAC-CE and the second MAC-CE allow or disallow transmission of one or more service data units (SDUs) that may be associated with an expired discard timer for a cell group.

In some examples of the method, UEs, and non-transitory computer-readable medium described herein, receiving the one or more respective messages may include operations, features, means, or instructions for receiving, from the first network entity, the second network entity, or both, a joint MAC-CE that may be indicative of an activation or deactivation status of the PSI-based discard procedure for the first network entity, the second network entity, or both.

In some examples of the method, UEs, and non-transitory computer-readable medium described herein, the joint MAC-CE includes two octets, a first octet including a first activation or deactivation status of the first network entity and a second octet including a second activation or deactivation status of the second network entity.

### BRIEF DESCRIPTION OF THE DRAWINGS

FIG. 1 shows an example of a wireless communications system that supports protocol data unit (PDU) set importance (PSI)-based discard in dual connectivity in accordance with one or more aspects of the present disclosure.

FIG. 2 shows an example of a network architecture that supports PSI-based discard in dual connectivity in accordance with one or more aspects of the present disclosure.

FIG. 3 shows an example of a wireless communications system that supports PSI-based discard in dual connectivity in accordance with one or more aspects of the present disclosure.

FIGS. 4 and 5 show examples of process flows that support PSI-based discard in dual connectivity in accordance with one or more aspects of the present disclosure.

FIG. 6 shows an example of a wireless communications system that supports PSI-based discard in dual connectivity in accordance with one or more aspects of the present disclosure.

FIGS. 7 and 8 show block diagrams of devices that support PSI-based discard in dual connectivity in accordance with one or more aspects of the present disclosure.

FIG. 9 shows a block diagram of a communications manager that supports PSI-based discard in dual connectivity in accordance with one or more aspects of the present disclosure.

FIG. 10 shows a diagram of a system including a device that supports PSI-based discard in dual connectivity in accordance with one or more aspects of the present disclosure.

FIGS. 11 and 12 show block diagrams of devices that support PSI-based discard in dual connectivity in accordance with one or more aspects of the present disclosure.

FIG. 13 shows a block diagram of a communications manager that supports PSI-based discard in dual connectivity in accordance with one or more aspects of the present disclosure.

FIG. 14 shows a diagram of a system including a device that supports PSI-based discard in dual connectivity in accordance with one or more aspects of the present disclosure.

FIGS. 15 through 19 show flowcharts illustrating methods that support PSI-based discard in dual connectivity in accordance with one or more aspects of the present disclosure.

### DETAILED DESCRIPTION

Some wireless communications systems may support dual connectivity, where a device such as a user equipment (UE) may communicate data from a data radio bearer (DRB) to different network entities. For example, the UE may communicate data via one or more protocol data units (PDUs) which may be included as part of a PDU set, and which may be associated with a discard timer that may help prevent excessive quantities of PDUs from piling up due to high traffic or network congestion. The PDU discard timers (and an associated PDU discard procedure) may indicate, to the UE, a duration to buffer PDUs before the UE is allowed to begin discarding the PDUs, where the PDU discard timers may be configured based on the relative importance of the PDU sets being buffered. For example, using PDU set importance (PSI)-based discard procedures, a first, relatively shorter timer may be configured for PDU sets having relatively lower importance (e.g., lower quality of service targets relative to other PDU sets, higher latency allowance relative to other PDU sets), whereas a second, relatively longer timer may be configured for PDU sets having relatively higher importance (e.g., higher quality of service targets relative to other PDU sets, lower latency allowance relative to other PDU sets).

In some cases, however, the network entities that the UE is connected with may make changes to the PSI-based discard procedure without coordination, which may cause challenges. For example, if a first network entity deactivates the PSI-based discard procedure when the second network entity is close to satisfying a congestion threshold, the second network entity is likely to become congested (e.g., satisfying the congestion threshold) after deactivation of the PSI-based discard procedure. In some other examples, if the first network entity activates the procedure without notifying the second network entity, the UE may begin discarding PDUs that the second network entity expects to receive. Further, if the UE receives conflicting information from the different network entities regarding the activation or deactivation of the PSI-based discard procedures, the UE may be unaware of how to handle different requests from each network entity.

To support efficient and coordinated PSI-based discard procedures in cases with a split DRB in dual connectivity, the network entities involved in the dual connectivity with the UE may coordinate whenever one node or both nodes make changes to the procedure state of the current PSI-based discard procedure. For example, the first network entity may communicate, with the second network entity, one or more messages that include an indication of at least one state change (e.g., an activation or a deactivation) of the PSI-based discard procedure. The communication of the one or more messages may occur either before or after the first network entity makes the change to the PSI-based discard procedure. The first and the second network entities may then communicate one or more messages (e.g., one or more medium access control-control elements (MAC-CEs), a PSI-based discard procedure state request message) with the UE to indicate the state change of the PSI-based discard procedure to coordinate the state change.

Coordination for changes in the activation or deactivation of a PSI-based discard procedure may allow for both network entities to efficiently perform network load balancing between the network entities, so that neither network entity becomes congested due to uncoordinated activation or deactivation of the PSI-based discard procedure. For example, the UE may not be instructed to start discarding PDUs or transmitting PDUs without knowledge of both network entities, and the network entities may be able to effectively gauge how much traffic to expect from the UE. Additionally, or alternatively, the coordination of changes in the activation or deactivation of a PSI-based discard procedure (e.g., a split DRB deployment that supports a PSI-based discard procedure) may allow for reduced latency and improved network and UE performance, because the discard or maintenance of PDU sets (e.g., via activation of the PSI-based discard procedure or deactivation of the PSI-based discard procedure) may be coordinated and communicated between each device in a dual connectivity deployment such that low-importance PDU sets can be discarded as appropriate and high-importance PDU sets can be maintained. Additionally, or alternatively, coordination for changes in the activation or deactivation of a PSI-based discard procedure may allow for reduced complexity and processing burden at the UE, which may obtain consistent (e.g., non-conflicting) information from both network entities regarding any changes to the state of the PSI-based discard procedure.

Aspects of the disclosure are initially described in the context of wireless communications systems. Aspects of the disclosure are further illustrated by and described with reference to process flows, apparatus diagrams, system diagrams, and flowcharts that relate to PSI-based discard in dual connectivity. Aspects of the disclosure are further described in the context of an outline, flowcharts, and tables.

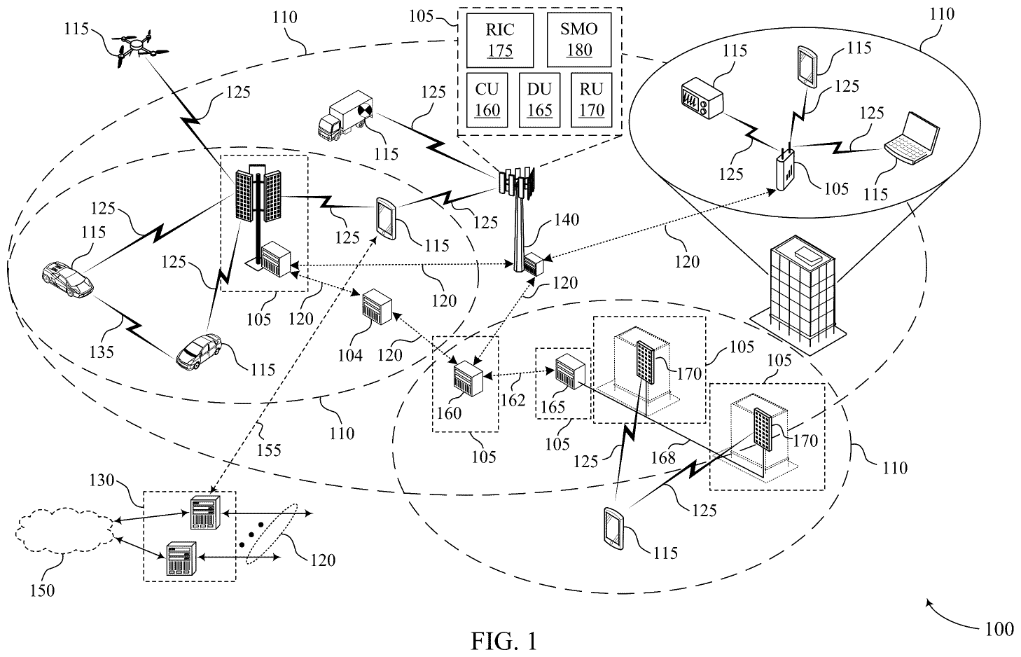

FIG. 1 shows an example of a wireless communications system 100 that supports PSI-based discard in dual connectivity in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

In some cases, a UE 115 may be served by cells from two or more network entities 105 (e.g., that are connected by a non-ideal backhaul) in dual connectivity operation. In some examples, the connection between the serving network entities 105 may not be sufficient to facilitate precise timing coordination. Thus, in some cases, the cells serving a UE 115 may be divided into multiple timing advance groups (TAGs). Each TAG may be associated with a different timing offset, such that the UE 115 may synchronize uplink transmissions differently for different uplink carriers.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TT1 duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support implementations of extended reality (XR), including real and virtual combined environments and human-machine interactions that may be generated by different technologies, devices, and wearables. XR may include different types of realities, including virtual reality (VR), augmented reality (AR), and mixed reality (MR).

In some aspects, XR implementations may utilize frame rates of at least 60 frames per second (FPS), and corresponding bit rates of tens of megabits per second, and information may be rendered using XR engines that are hosted external to a UE due to heat dissipation and battery constraints at the UE 115. In some aspects, rendering and other processes and communications for XR can be split across the wireless communications system 100, where the UE sends real-time sensor data in uplink to a network entity or to the cloud, which then performs rendering and produces data which is sent back to the UE.

In both uplink and downlink scenarios, XR communications may use PDU sets and data bursts to allow the network to identify PDUs which carry content (e.g., data), and that can be processed as a single unit (e.g., a portion of an image, an audio frame). In some implementations, the network or a UE 115 may determine whether all PDUs of the PDU set are needed for the usage, or whether certain PDUs can be discarded. For example, a PDU set may be associated with an importance indicator, which may be indicative of the relative importance of a PDU set compared to other PDU sets. The network or the UE may then discard relatively lower importance PDU sets in case of network congestion.

In some implementations, XR may be implemented in a dual-connectivity or split bearer deployment, where a UE 115 may be connected to at least two network nodes. For example, the UE 115 (while in an RRC connected mode) may utilize communications resources of two different network entities (e.g., a master node and a secondary node) that are connected via a backhaul link over an X2 interface. The UE 115 may transmit data from a first DRB to the master node and from a second DRB to the secondary node. In some aspects, dual connectivity may support improved data rates, extended coverage for the UE 115, improved mobility, load balancing, and latency reduction, among other improvements. XR dual connectivity may also support PDU set handling, burst time arrival reporting, and explicit congestion notification (ECN). In some examples, the wireless communications system 100 may support ECN marking requests or responses for master node and/or secondary node terminated secondary cell group and master cell group bearers and split bearers. In some examples, the wireless communications system 100 may support delivering PDCP PDUs with PDU set-up information (e.g., congestion information over Xn-U interface). Additionally, or alternatively, XR dual connectivity may support PSI discard coordination among different network entities 105 or UEs 115 within the wireless communications system 100.

In some cases, the different network entities 105 that the UE 115 is connected with may make changes to the PSI-based discard procedure without coordination, which may cause challenges. For example, if a first network entity 105 deactivates the PSI-based discard procedure when a second network entity 105 is close to congestion (e.g., close to satisfying a congestion threshold), the second network entity 105 is likely to become congested after deactivation of the PSI-based discard procedure. In some other examples, if the first network entity 105 activates the procedure without notifying the second network entity 105, the UE 115 may begin discarding PDUs that the second network entity 105 expects to receive. Further, if the UE 115 receives conflicting information from the different network entities regarding the activation or deactivation of the PSI-based discard procedures, the UE 115 may be unaware of how to handle different requests from each network entity.

To support efficient PSI-based discard procedures in cases with a split DRB in dual connectivity, the network entities 105 involved in the dual connectivity with the UE 115 may coordinate whenever one node or both nodes make changes to the procedure state of the current PSI-based discard procedure. For example, the first network entity 105 may communicate, with the second network entity 105, one or more messages that include an indication of at least one state change (e.g., an activation or a deactivation) of the PSI-based discard procedure. The communication of the one or more messages may occur either before or after the first network entity 105 makes the change to the PSI-based discard procedure. The first and the second network entities 105 may then communicate one or more MAC-CEs with the UE to indicate the state change of the PSI-based discard procedure to coordinate the state change.

In some examples, one or more network nodes described with reference to FIG. 1 (e.g., a UE 115, a network entity 105) may be configured to perform one or more techniques as described in the present disclosure, including one or more techniques described herein.

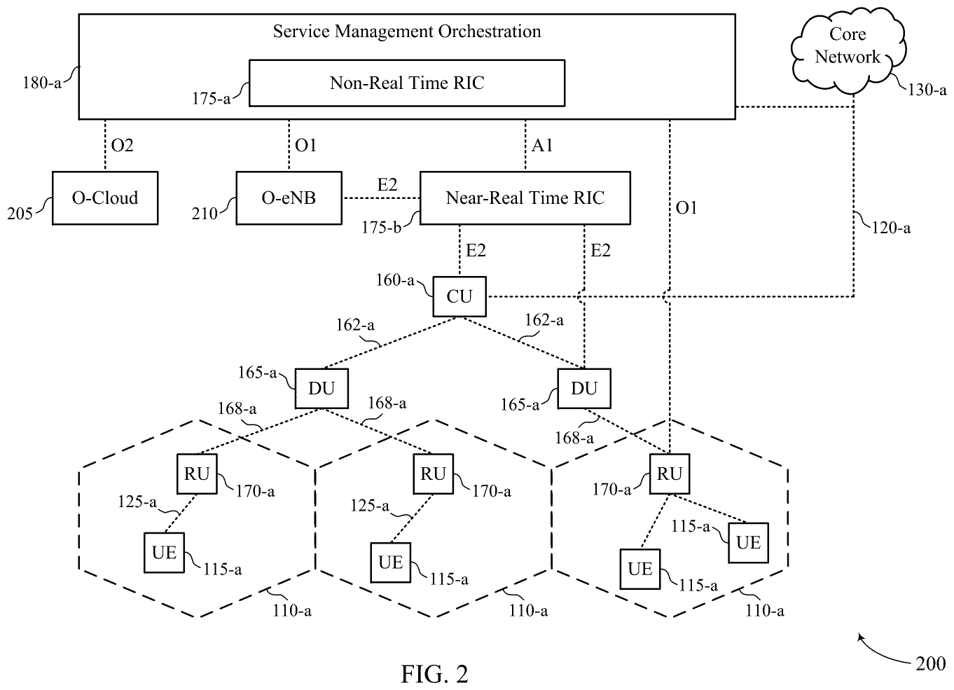

FIG. 2 shows an example of a network architecture 200 (e.g., a disaggregated base station architecture, a disaggregated RAN architecture) that supports PSI-based discard in dual connectivity in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

The network architecture 200 may support a dual connectivity deployment with one or more UEs 115-a. In some implementations, PSI-based discard procedure coordination messages may be communicated between DUs 165 and CUs 160, among other network components of the network architecture 200. For example, the DUs 165 and CUs 160 may support inter-node coordination for implementing PSI-based discard procedures for a UE 115-a. In such cases, the DUs 165 and CUs 160 may agree to a next procedure state (deactivated or activated) for the PSI-based discard procedure in advance of triggering the next procedure state. Additionally, or alternatively, the DUs 165 and/or CUs 160 may update the procedure state and then notify the other node of the change.

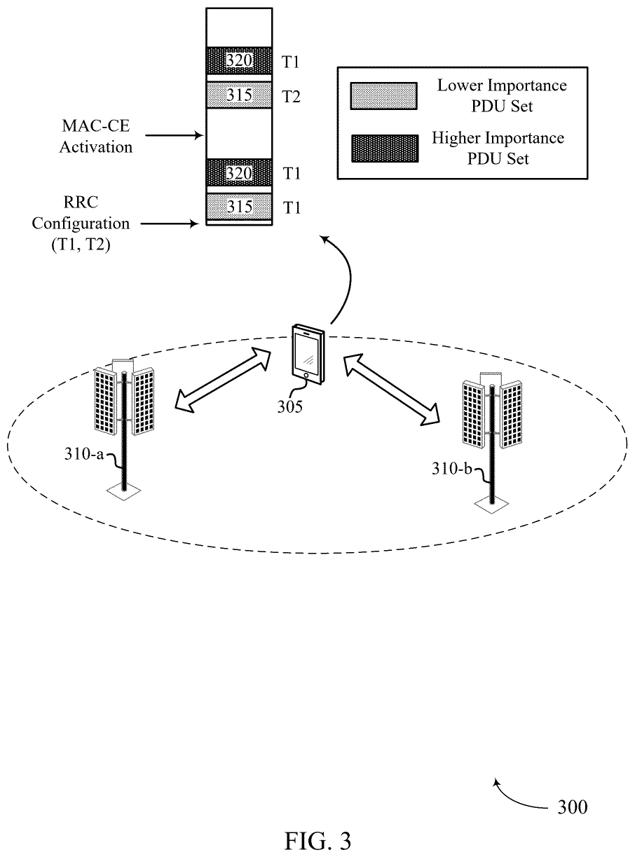

FIG. 3 shows an example of a wireless communications system 300 that supports PSI-based discard in dual connectivity in accordance with one or more aspects of the present disclosure. For example, the wireless communications system 300 may support communications between a UE 305 and one or more network entities (e.g., a first network entity 310-a and a second network entity 310-b), which may be examples of corresponding devices described herein. In some aspects, the UE 305 may support operating in a split bearer or dual connectivity deployment with both the first network entity 310-a and the second network entity 310-b.

The wireless communications system 300 may support dual connectivity, where the UE 305 may communicate data from a DRB to a first network entity 310-a (e.g., a master node) or a second network entity 310-b (e.g., a secondary node) via different layers of a protocol stack. For example, data may be conveyed via PDUs or PDU sets, and one or more PDUs may be included in a PDU set. For example, the UE 305 may communicate different types of data (e.g., low latency traffic, XR traffic) via different PDU sets in order to support low latency communications and high data rates. In some aspects, different PDU sets may be associated with a discard timer to prevent relatively large quantities of PDUs from piling up due to high traffic (or a large quantity of relatively low importance PDUs). The PDU discard timers (and an associated PDU discard procedure) may indicate to the UE 305 a duration for which to buffer PDUs before discarding the PDU based on the importance (or one or more importance metrics) of different PDUs being buffered.

In some aspects, UE 305 may support PSI-based discard procedures to determine which PDU sets to keep or transmit, and which PDU sets may be discarded. For example, a first, shorter discard timer (e.g., T2) may be configured for PDU sets having relatively lower importance (e.g., higher latency, lower quality, lower urgency), whereas a second, relatively longer timer (e.g., T1) may be configured for PDU sets having relatively higher importance (e.g., lower latency, higher quality, higher urgency). In some implementations, the UE 305 may receive one or more RRC messages that include an RRC configuration that indicates a set of discard times to apply for the lower importance PDU set 315 and for the higher importance PDU set 320. In some aspects, discard timers may be configured per DRB via the RRC configuration. In some cases, the RRC configuration may allow the UE 305 to identify which PDU sets have a relatively higher importance, and which PDU sets have relatively lower importance. In some implementations, an indication of the relative importance of the PDU sets may be signaled via a user plane interface, where each PDU set may be associated with different metadata that is indicative of the relative importance of the PDU set.

In some aspects, relatively shorter discard timers may be applied to the lower importance PDU sets (e.g., for cases of congestion at one or both network entities), and relatively longer discard timers may be applied to higher importance PDU sets. For example, at an initial time, both the lower importance PDU set 315 and for the higher importance PDU set 320 may be configured with the discard timer duration T1, and the RRC configuration may indicate a different set of discard timers (e.g., the RRC configuration may indicate a shorter discard timer duration T2 for the lower importance PDU set 315). The UE 305 may then receive an activation MAC-CE which activates the timer durations indicated by the RRC configuration, and may discard PDU sets according to the duration T2 for the lower-importance PDU set 315 and according to the duration T1 for the higher-importance PDU set 320. In some cases, the MAC-CE may be a PSI-based service data unit (SDU) discard procedure activation MAC-CE or deactivation MAC-CE which includes one or more fields. For example, one or more fields of the MAC-CE may indicate the activation or deactivation status of the PSI-based SDU discard procedure per DRB (e.g., where the DRB identifiers are organized in ascending order among the DRBs configured with PSI-based SDU discard, and with RLC entities associated with a MAC entity associated with the MAC-CE).

In some cases, however, the two different network entities that the UE 305 is connected with (e.g., the first network entity 310-a and the second network entity 310-b) may make changes to the PDU discard procedure without coordinating with one another. This lack of coordination may cause challenges, for example, if the first network entity 310-a deactivates the PSI-based discard procedure when the second network entity 310-b is close to congestion, such that the second network entity 310-b is likely to become congested after deactivation of the PSI-based discard procedure. Additionally, or alternatively, if the first network entity 310-a activates the procedure without notifying the second network entity 310-b, the UE 305 may begin discarding PDUs that the second network entity 310-b expects to receive. Further, if the UE 305 receives conflicting information from the network entities regarding the activation or deactivation of the PSI-based discard procedures, the UE 305 may be unaware of how to handle different requests from each node.

To support efficient and coordinated PSI-based discard procedures with a split DRB deployment, the network entities involved in dual connectivity with the UE 305 (e.g., the first network entity 310-a and the second network entity 310-b) may coordinate whenever one network entity or both network entities make changes to the procedure state of the current PDU discard procedure. In some implementations, when either of the network entities decide to make changes to the PDU discard procedure state (e.g., whether the PDU discard procedure is deactivated or activated), the network entity may notify the other network entity of the change before making the change. In some such implementations, the network entity may wait for the other network entity to approve or deny the proposed change. In some other implementations, either network entity may make a change to the PDU discard procedure state and then notify the other network entity of the change after the change is made. The network entities may thus coordinate the changes to the PDU discard procedure via signaling, and once coordination occurs, both network entities may be aware of the activation state of the PSI based discard procedure. In some examples, one of the first network entity 310-a or the second network entity 310-b (or both network entities) may send a joint MAC-CE (e.g., a single MAC-CE) or separate MAC-CEs (e.g., two MAC-CEs) to the UE 305 to notify the UE 305 of the change.

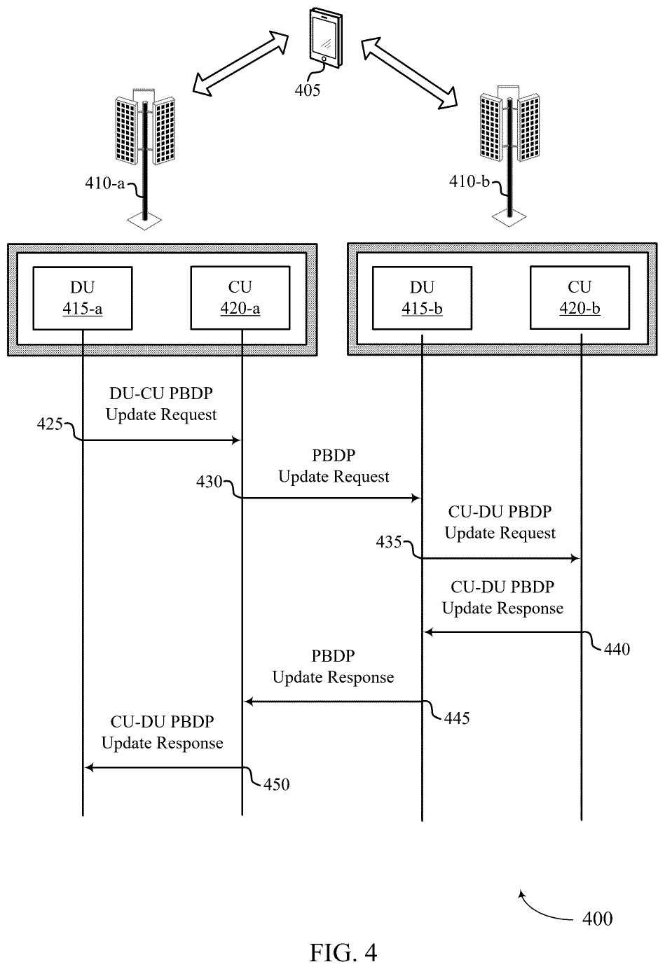

FIG. 4 shows an example of a process flow 400 that supports PSI-based discard in dual connectivity in accordance with one or more aspects of the present disclosure. For example, the process flow 400 may support communications between a UE 405 and one or more network entities (e.g., a first network entity 410-a and a second network entity 410-b), which may be examples of corresponding devices described herein. In some aspects, the UE 405 may support operating in a split bearer or dual connectivity deployment with both the first network entity 410-a and the second network entity 410-b. In some examples, the first network entity 410-a may be associated with a DU 415-a and a CU 420-a, and the second network entity 410-b entity may be associated with a DU 415-b and a CU 420-b, each of which may be examples of DUs 165 and CUs 160 described herein.

Alternative examples of the following may be implemented. Some steps are performed in a different order than described or are not performed at all. In some implementations, steps may include additional features not mentioned below, or additional steps may be added. Further, although the UE 405, the first network entity 410-a, and the second network entity 410-b are shown performing the operations of the process flow 400, some aspects of some operations may also be performed by one or more other wireless communication devices (such as by multiple network entities, multiple UEs, or in accordance with coordination among multiple network entities in a dual connectivity deployment).

In some implementations, the UE 405 may support a PSI-based discard procedure to reduce latency and processing burden. For example, the PSI-based discard procedure may indicate one or more discard timers associated with different PDU sets, and the UE 405 may discard the PDU sets once the discard timers expire. In some cases, the network may modify or reconfigure the PSI-based discard procedure based on various factors, such as packet importance, latency requirements, increased or decreased bit rates, among other factors. To support coordinated PSI-based discard procedure updates, the network entities involved in dual connectivity with the UE 405 (e.g., the first network entity 410-a and the second network entity 410-b) may coordinate whenever one network entity or both network entities make changes to the procedure state of the current PDU discard procedure. For example, whenever a network entity or network node that is involved in a dual-connectivity deployment (with a split DRB configuration) determines an update to the state (e.g., activation or deactivation) of the PSI-based discard procedure, the network entity may send a request for the other network entity to approve or reject the update. In some implementations, the network entity that sends the update request may wait to receive a response from the other network entity before proceeding with the update.

At 425, the DU 415-a associated with the first network entity 410-a may output, via an F1 interface between the DU 415-a and the CU 420-a, a DU to CU PSI-based discard procedure (PBDP) update request to the CU 420-a associated with the first network entity 410-a. In some examples, the PSI-based discard procedure update request may be output via one or more F1-application protocol (AP) messages via the F1 interface, where the one or more F1-AP messages include a UE context modification request message, a UE context modification required message, a UE PSI-based discard procedure update request message (from CU to DU), a UE PSI-based discard procedure update required message (from DU to CU), or any combination thereof.

In some implementations, the UE context modification request message, the UE context modification required message, the UE PSI-based discard procedure update request message (from CU to DU), the UE PSI-based discard procedure update required message (from DU to CU), or any combination thereof, may include an information element or field that indicates the PSI-based discard procedure state request (e.g., a PSI-based discard procedure state request information element). The PSI-based discard procedure state request information element may include one or more bits where a first bit value (e.g., “0”) indicates that the CU 420-a or DU 415-a of the first network entity 410-a requests for the PSI-based discard procedure state to be deactivated for an associated DRB, and a second bit value (e.g., “1”) indicates that the CU 420-a or DU 415-a of the first network entity 410-a requests for the PSI-based discard procedure state to be activated for an associated DRB. In some implementations, the PSI-based discard procedure state request information element may be included with one or more other fields in the UE context modification request message, the UE context modification required message, the UE PSI-based discard procedure update request message (from CU to DU), the UE PSI-based discard procedure update required message (from DU to CU), or any combination thereof. For example, the UE context modification request message, the UE context modification required message, the UE PSI-based discard procedure update request message (from CU to DU), the UE PSI-based discard procedure update required message (from DU to CU), or any combination thereof, may include a DRB required to be modified list, one or more DRB required to be modified item information elements, the PSI-based discard procedure state request information element, or any combination thereof. Aspects of the PSI-based discard procedure state request information element may be further described herein with reference to Table 1.

In some aspects, the UE context modification request message, the UE context modification required message, the UE PSI-based discard procedure update request message (from CU to DU), the UE PSI-based discard procedure update required message (from DU to CU), or any combination thereof, may include a PSI-based discard procedure MAC-CE request information element, which includes a MAC-CE (or an indication of the MAC-CE) that the first network entity 410-a requests to send to the UE 405. In some aspects, the MAC-CE request information element may indicate one or more formats of the MAC-CE that the first network entity 410-a may send to the UE 405.

At 430, the CU 420-a associated with the first network entity 410-a may output, via an Xn interface between the CU 420-a and the DU 415-b associated with the second network entity 410-b, the PSI-based discard procedure (e.g., PBDP) update request message. In some examples, the PSI-based discard procedure update request message may be part of an Xn-AP message such as a secondary node modification request message, a secondary node modification required message, or both. In some other examples, the PSI-based discard procedure update request message may be part of an Xn-AP message such as a secondary node PSI-based discard procedure update request message (e.g., from a master node to a secondary node), a secondary node PSI-based discard procedure update required message (e.g., from the secondary node to the master node), or both.

In some implementations, the secondary node modification request message, the secondary node modification required message, the secondary node PSI-based discard procedure update request message, the secondary node PSI-based discard procedure update required message, or any combination thereof, may include an information element or field that indicates the PSI-based discard procedure state request (e.g., a PSI-based discard procedure state request information element). The PSI-based discard procedure state request information element may include one or more bits where a first bit value (e.g., “0”) indicates that the first network entity 410-a (which may be a master node or secondary node) requests for the PSI-based discard procedure state to be deactivated, and a second bit value (e.g., “1”) indicates that the first network entity 410-a requests for the PSI-based discard procedure state to be activated. For example, the information element may include the information illustrated in Table 1:

TABLE 1
PSI Based Discard Procedure State Request Information Element

| Presence | Range | Description |
|---|---|---|
| Optional | 0.1 | States that the master node or secondary node requests |
| | | for the PSI- Based Discard Procedure of the DRB ID: |
| | | 0 means ‘deactivated’ |
| | | 1 means ‘activated’ |

In some implementations, the PSI-based discard procedure state request information element may be included with one or more other fields in the secondary node modification request message, the secondary node modification required message, the secondary node PSI-based discard procedure update request message, the secondary node PSI-based discard procedure update required message, or any combination thereof. For example, the secondary node modification request message, the secondary node modification required message, the secondary node PSI-based discard procedure update request message, the secondary node PSI-based discard procedure update required message, or any combination thereof, may include a PDU session resources to be modified list, a PDU session resources to be modified item, PDU session resource modification information (terminated at a secondary node or a master node), a list of DRBs that are to be modified (e.g., DRBs to be modified list), a DRBs to be modified item, the PSI-based discard procedure state request information element, or any combination thereof. In some aspects, the components of the secondary node modification request message, the secondary node modification required message, the secondary node PSI-based discard procedure update request message, the secondary node PSI-based discard procedure update required message, or any combination thereof, may be ordered as follows:
>PDU Session Resources to be Modified List
   >>PDU Session Resources to be Modified Item
      >>>PDU Session Resource Modification Info-SN terminated (or MN terminated)
         >>>>DRBs to be Modified List
         >>>>>DRBs to be Modified Item
         >>>>>PSI Based Discard Procedure State Request

In some other implementations, the secondary node modification request message, the secondary node modification required message, the secondary node PSI-based discard procedure update request message, the secondary node PSI-based discard procedure update required message, or any combination thereof, may include a PSI-based discard procedure MAC-CE request information element, which includes a MAC-CE (or an indication of the MAC-CE) that the first network entity 410-a requests to send to the UE 405. In some aspects, the MAC-CE request information element may indicate one or more formats of the MAC-CE that the first network entity 410-a may send to the UE 405.

At 435, the DU 415-b associated with the second network entity 410-b may output, to the CU 420-b associated with the second network entity 410-b, a CU to DU PSI-based discard procedure (e.g., PBDP) update request via an F1 interface. In some examples, the PSI-based discard procedure update request may be output via one or more F1-AP messages via the F1 interface, where the one or more F1-AP messages include a UE context modification request message, a UE context modification required message, a UE PSI-based discard procedure update request message (from CU to DU), a UE PSI-based discard procedure update required message (from DU to CU), or any combination thereof.

At 440, the CU 420-b associated with the second network entity 410-b may output, via an F1 interface to the DU 415-b associated with the second network entity 410-b, a CU to DU PSI-based discard procedure (e.g., PBDP) update response which includes an acceptance or rejection of the PSI-based discard procedure update request. In some examples, the PSI-based discard procedure update response may be output via one or more F1-AP messages via the F1 interface, where the one or more F1-AP messages include a UE context modification response message, a UE context modification confirm message, a UE PSI-based discard procedure update response message (from DU to CU), a UE PSI-based discard procedure update confirm message from CU to DU), or any combination thereof. In some implementations, the UE context modification response message, the UE context modification confirm message, the UE PSI-based discard procedure update response message (from DU to CU), the UE PSI-based discard procedure update confirm message from CU to DU), or any combination thereof, may include an information element or field that indicates the PSI-based discard procedure state response (e.g., a PSI-based discard procedure state response information element). In some cases, the PSI-based discard procedure state response information element may be included in the UE context modification response message, a UE context modification confirm message, the UE PSI-based discard procedure update response message (from DU to CU), the UE PSI-based discard procedure update confirm message from CU to DU), or any combination thereof, along with one or more other information elements such as a DRB modified list, and one or more DRB modified item information elements.

The PSI-based discard procedure state response information element may include one or more bits, such as a first bit value (e.g., “0”) and a second bit value (e.g., “1”). In some examples, a bit value of 0 in the PSI-based discard procedure state response information element may indicate that the second network entity 410-b has denied the PSI-based discard procedure state request for a DRB, while a bit value of 1 in the PSI-based discard procedure state response information element may indicate that the second network entity 410-b has accepted the PSI-based discard procedure state request for the DRB. In some other examples, a bit value of 0 in the PSI-based discard procedure state response information element may indicate that the second network entity 410-b requests a deactivation of the PSI-based discard procedure for a DRB, while a bit value of 1 in the PSI-based discard procedure state response information element may indicate that the second network entity 410-b requests an activation of the PSI-based discard procedure for a DRB. Aspects of the PSI-based discard procedure state response information element may be further described herein with reference to Table 2.

In some other implementations, the UE modification response message, the UE context modification confirm message, the UE PSI-based discard procedure update response message (from DU to CU), the UE PSI-based discard procedure update confirm message from CU to DU), or any combination thereof, may include a PSI-based discard procedure MAC-CE response information element, which includes a MAC-CE (or an indication of the MAC-CE) that includes or represents the feedback (e.g., acceptance or rejection) for the requested update to the PSI-based discard procedure proposed by the first network entity 410-a. In some aspects, the MAC-CE response information element may indicate one or more formats of the MAC-CE that the first network entity 410-a may send to the UE 405.

At 445, the DU 415-b associated with the second network entity 410-b may output, via an Xn interface to the CU 420-a associated with the first network entity 410-a, the PSI-based discard procedure (e.g., PBDP) update response message that includes the acceptance or rejection of the PSI-based discard procedure update request. In some examples, the PSI-based discard procedure update response message may be part of an Xn-AP message (e.g., Xn-AP layer signaling), such as a secondary node modification request acknowledge message, a secondary node modification confirm message, or both. In some other examples, the PSI-based discard procedure update response message may be part of an Xn-AP message such as a secondary node PSI-based discard procedure update request acknowledge message (e.g., from a secondary node to a master node). a secondary node PSI-based discard procedure update confirm message (e.g., from the master node to the secondary node), or both.

In some implementations, the secondary node modification request acknowledge message, the secondary node modification confirm message, the secondary node PSI-based discard procedure update request acknowledge message, the secondary node PSI-based discard procedure update confirm message, or any combination thereof, may include an information element or field that indicates the PSI-based discard procedure state response (e.g., a PSI-based discard procedure state response information element). The PSI-based discard procedure state response information element may include one or more bits, such as a first bit value (e.g., “0”) and a second bit value (e.g., “1”). In some examples, a bit value of 0 in the PSI-based discard procedure state response information element may indicate that the second network entity 410-b has denied the PSI-based discard procedure state request for a DRB, while a bit value of 1 in the PSI-based discard procedure state response information element may indicate that the second network entity 410-b has accepted the PSI-based discard procedure state request for the DRB. In some other examples, a bit value of 0 in the PSI-based discard procedure state response information element may indicate that the second network entity 410-b requests a deactivation of the PSI-based discard procedure for a DRB, while a bit value of 1 in the PSI-based discard procedure state response information element may indicate that the second network entity 410-b requests an activation of the PSI-based discard procedure for a DRB. Different examples of the PSI-based discard procedure state response information element are illustrated in Table 2:

TABLE 2
PSI-Based Discard Procedure State Response

| Presence | Range | Description 1 | Description 2 |
|---|---|---|---|
| Optional | 0 . . . 1 | Response from | State of the |
| | | the MN/SN | PSI-based discard |
| | | to the state suggested | procedure that |
| | | by the SN/MN | the MN/SN is |
| | | for the PSI Based | replying to the |
| | | Discard Procedure | SN/MN for a |
| | | of a DRB | DRB |
| | | 0 means ‘denied’ | 0 means ‘deactivated’ |
| | | 1 means ‘accepted’ | 1 means ‘activated’ |

In some implementations, the PSI-based discard procedure state response information element may be included with one or more other fields in the secondary node modification request acknowledge message or the secondary node PSI-based discard procedure update request acknowledge message. For example, the secondary node modification request acknowledge message or the secondary node PSI-based discard procedure update request acknowledge message may include a PDU session resources admitted to be modified list, a PDU session resources admitted to be modified item, PDU session resource modification response information (terminated at a secondary node or a master node), a list of DRBs that are to be modified (e.g., DRBs to be modified list), a DRBs to be modified item, the PSI-based discard procedure state response information element, or any combination thereof. In some aspects, the components of the secondary node modification request acknowledge message, or the secondary node PSI-based discard procedure update request acknowledge message may be ordered as follows:
>PDU Session Resources Admitted to be Modified List
   >>PDU Session Resources Admitted to be Modified Item
      >>>PDU Session Resource Modification Response Info-SN terminated (or MN terminated)
         >>>>DRBs to be Modified List
         >>>>>DRBs to be Modified Item
         >>>>>PSI Based Discard Procedure State Response

Additionally, or alternatively, the PSI-based discard procedure state response information element may be included with one or more other fields in the secondary node modification confirm message or the secondary node PSI-based discard procedure update confirm message. For example, the secondary node modification confirm message or the secondary node PSI-based discard procedure update confirm message may include a PDU session resources admitted to be modified list, a PDU session resources admitted to be modified item, PDU session resource modification confirmation information (terminated at a secondary node or a master node), a list of DRBs that are to be admitted to be setup or modified (e.g., DRBs admitted to be setup or modified list), a DRBs to be setup or modified item, the PSI-based discard procedure state response information element, or any combination thereof. In some aspects, the components of the secondary node modification request acknowledge message, or the secondary node PSI-based discard procedure update confirm message may be ordered as follows:
>PDU Session Resources Admitted to be Modified List
   >>PDU Session Resources Admitted to be Modified Item
      >>>PDU Session Resource Modification Confirm Info-SN terminated (or MN terminated)
         >>>>DRBs Admitted to be Setup or Modified List
         >>>>>DRBs Admitted to be Setup or Modified Item
         >>>>>PSI Based Discard Procedure State Response

In some other implementations, the secondary node modification request acknowledge message, the secondary node modification confirm message, the secondary node PSI-based discard procedure update request message, the secondary node PSI-based discard procedure update confirm message, or any combination thereof may include a PSI-based discard procedure MAC-CE response information element, which includes a MAC-CE (or an indication of the MAC-CE) that includes or represents the feedback (e.g., acceptance or rejection) for the requested update to the PSI-based discard procedure proposed by the first network entity 410-a. In some aspects, the MAC-CE response information element may indicate one or more formats of the MAC-CE that the first network entity 410-a may send to the UE 405.

In some cases, the second network entity 410-b may be unable to process the PSI-based discard procedure update request message from the first network entity 410-a. In such error cases, the second network entity 410-b may output, using an Xn-AP message via the Xn interface, a secondary node PSI-based discard procedure update request reject message, a secondary node PSI-based discard procedure update refuse message, or both. Additionally, or alternatively, the second network entity 410-b may output, using an F1-AP message via the F1 interface, a UE PSI-based discard procedure update failure message (e.g., from DU to CU), a UE PSI-based discard procedure update refuse message (e.g., from CU to DU), or both.

At 450, the CU 420-a associated with the first network entity 410-a may output, via an F1 interface to the DU 415-a associated with the first network entity 410-a, a CU to DU PSI-based discard procedure (e.g., PBDP) update response from the second network entity 410-b. In some examples, the PSI-based discard procedure update response may be output via one or more F1-AP messages via the F1 interface, where the one or more F1-AP messages include a UE context modification response message, a UE context modification confirm message, a UE PSI-based discard procedure update response message (from DU to CU), a UE PSI-based discard procedure update confirm message from CU to DU), or any combination thereof. In some implementations, the UE context modification response message, the UE context modification confirm message, the UE PSI-based discard procedure update response message (from DU to CU), the UE PSI-based discard procedure update confirm message from CU to DU), or any combination thereof, may include an information element or field that indicates the PSI-based discard procedure state response (e.g., a PSI-based discard procedure state response information element). In some cases, the PSI-based discard procedure state response information element may be included in the UE context modification response message, a UE context modification confirm message, or both, along with one or more other information elements such as a DRB modified list, and one or more DRB modified item information elements.

The PSI-based discard procedure state response information element may include one or more bits, such as a first bit value (e.g., “0”) and a second bit value (e.g., “1”). In some examples, a bit value of 0 in the PSI-based discard procedure state response information element may indicate that the second network entity 410-b has denied the PSI-based discard procedure state request for a DRB, while a bit value of 1 in the PSI-based discard procedure state response information element may indicate that the second network entity 410-b has accepted the PSI-based discard procedure state request for the DRB. In some other examples, a bit value of 0 in the PSI-based discard procedure state response information element may indicate that the second network entity 410-b requests a deactivation of the PSI-based discard procedure for a DRB, while a bit value of 1 in the PSI-based discard procedure state response information element may indicate that the second network entity 410-b requests an activation of the PSI-based discard procedure for a DRB. Aspects of the PSI-based discard procedure state response information element may be further described herein with reference to Table 2.

In some other implementations, the UE modification response message, the UE context modification confirm message, the UE PSI-based discard procedure update response message (from DU to CU), the UE PSI-based discard procedure update confirm message from CU to DU), or any combination thereof, may include a PSI-based discard procedure MAC-CE response information element, which includes a MAC-CE (or an indication of the MAC-CE) that includes or represents the feedback (e.g., acceptance or rejection) for the requested update to the PSI-based discard procedure proposed by the first network entity 410-a. In some aspects, the MAC-CE response information element may indicate one or more formats of the MAC-CE that the first network entity 410-a may send to the UE 405.

Once the first network entity 410-a (e.g., the initiating node) receives a response from the second network entity 410-b, the first network entity 410-a may send a joint MAC-CE to the UE 405 that includes the activation or deactivation status of the PSI-based discard procedure for both network entities. In some examples, the second network entity 410-b may transmit to the joint MAC-CE to the UE 405. In some aspects, the MAC-CE may be a “dual connectivity PSI-based discard activation/deactivation MAC-CE” that is specific to indicating the joint activation or deactivation status of the PSI-based discard procedure at both network entities. For example, the dual connectivity PSI-based discard activation/deactivation MAC-CE may have a size of two octets, where the first octet indicates the activation or deactivation status of the first network entity 410-a (or whichever network entity transmitted the joint MAC-CE), and the second octet indicates the activation or deactivation status from the second network entity 410-b (or whichever network entity did not transmit the joint MAC-CE).

In some aspects, the first network entity 410-a, the second network entity 410-b, or both, may report an indication of a capability to support coordination before the PSI-based discard procedure state update. For example, the first network entity 410-a and the second network entity 410-b may each report the capability via one or more Xn-AP messages via the Xn interface. The one or more Xn-AP messages may include a secondary node addition request message, a secondary node addition request acknowledge message, a secondary node modification request message, a secondary node modification request acknowledge message, a secondary node modification required message, a secondary node modification confirm message, or any combination thereof. In such examples, the one or more Xn-AP messages may include an indication of the capability for the first network entity 410-a or the second network entity 410-b to support coordination before the PSI-based discard procedure state update.

In some other examples, the first network entity 410-a and the second network entity 410-b may each report the capability via one or more F1-AP messages via the F1 interface. The one or more F1-AP messages may include a UE context setup request message, a UE context setup response message, a UE context modification request message, a UE context modification response message, a UE context modification required message, a UE context modification confirm message, or any combination thereof. In such examples, the one or more F1-AP messages may include an indication of the capability for the first network entity 410-a or the second network entity 410-b to support coordination before the PSI-based discard procedure state update.

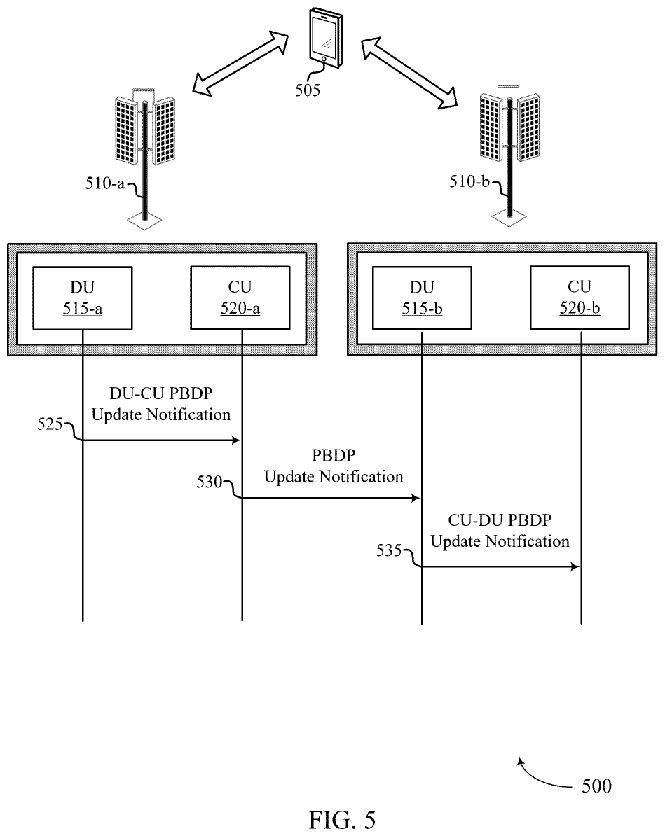

FIG. 5 shows an example of a process flow 500 that supports PSI-based discard in dual connectivity in accordance with one or more aspects of the present disclosure. For example, the process flow 500 may support communications between a UE 505 and one or more network entities (e.g., a first network entity 510-a and a second network entity 510-b), which may be examples of corresponding devices described herein. In some aspects, the UE 505 may support operating in a split bearer or dual connectivity deployment with both the first network entity 510-a and the second network entity 510-b. In some examples, the first network entity 510-a may be associated with a DU 515-a and a CU 520-a, and the second network entity 510-b entity may be associated with a DU 515-b and a CU 520-b, each of which may be examples of DUs 165 and CUs 160 described herein.

Alternative examples of the following may be implemented. Some steps are performed in a different order than described or are not performed at all. In some implementations, steps may include additional features not mentioned below, or additional steps may be added. Further, although the UE 505, the first network entity 510-a, and the second network entity 510-b are shown performing the operations of the process flow 500, some aspects of some operations may also be performed by one or more other wireless communication devices (such as by multiple network entities, multiple UEs, or in accordance with coordination among multiple network entities in a dual connectivity deployment).

In some implementations, the UE 505 may support a PSI-based discard procedure to reduce latency and processing burden. For example, the PSI-based discard procedure may indicate one or more discard timers associated with different PDU sets, and the UE 505 may discard the PDU sets once the discard timers expire. In some cases, the network may modify or reconfigure the PSI-based discard procedure based on various factors, such as packet importance, latency requirements, increased or decreased bit rates, among other factors. To support coordinated PSI-based discard procedure updates, the network entities involved in dual connectivity with the UE 505 (e.g., the first network entity 510-a and the second network entity 510-b) may coordinate whenever one network entity or both network entities make changes to the procedure state of the current PDU discard procedure. For example, a network entity or network node that is involved in a dual-connectivity deployment (with a split DRB configuration) may update a state of the PSI-based discard procedure (e.g., either activate or deactivate the PSI-based discard procedure), and may send an indication or notification of the updated state of the PSI-based discard procedure to the other network entity.

At 525, the DU 515-a associated with the first network entity 510-a may output, via an F1 interface between the DU 515-a and the CU 520-a, a DU to CU PBDP notification to the CU 520-a associated with the first network entity 510-a. The PSI-based discard procedure notification may be indicative of an activation or deactivation (or a change) to the PSI-based discard procedure that was implemented by the first network entity 510-a. In some examples, the PSI-based discard procedure update request may be output via one or more F1-AP messages via the F1 interface, where the one or more F1-AP messages include a UE context modification request message, a UE context modification required message, a UE PSI-based discard procedure update notification message (from CU to DU), a UE PSI-based discard procedure update notification required message (from DU to CU), or any combination thereof.

In some implementations, the UE context modification request message, the UE context modification required message, the UE PSI-based discard procedure update notification message (from CU to DU), the UE PSI-based discard procedure update notification required message (from DU to CU), or any combination thereof, may include an information element or field that indicates the PSI-based discard procedure state request (e.g., a PSI-based discard procedure state request information element). The PSI-based discard procedure state request information element may include one or more bits where a first bit value (e.g., “0”) indicates that the CU 520-a or DU 515-a of the first network entity 510-a requests for the PSI-based discard procedure state to be deactivated for an associated DRB, and a second bit value (e.g., “1”) indicates that the CU 520-a or DU 515-a of the first network entity 510-a requests for the PSI-based discard procedure state to be activated for an associated DRB.

In some aspects, the UE context modification request message, the UE context modification required message, the UE PSI-based discard procedure update notification message (from CU to DU), the UE PSI-based discard procedure update notification required message (from DU to CU), or any combination thereof, may include a PSI-based discard procedure MAC-CE request information element, which includes a MAC-CE (or an indication of the MAC-CE) that the first network entity 510-a requests to send to the UE 505. In some aspects, the MAC-CE request information element may indicate one or more formats of the MAC-CE that the first network entity 510-a may send to the UE 505.

At 530, the CU 520-a associated with the first network entity 510-a may output, via an Xn interface between the CU 520-a and the DU 515-b, PSI-based discard procedure update notification to the DU 515-b associated with the second network entity 510-b. In some examples, the PSI-based discard procedure update notification message may be part of an Xn-AP message such as a secondary node modification request message, a secondary node modification required message, or both. In some other examples, the PSI-based discard procedure update request message may be part of an Xn-AP message such as a secondary node PSI-based discard procedure update notification message (e.g., from a master node to a secondary node), a secondary node PSI-based discard procedure update notification required message (e.g., from the secondary node to the master node), or both.

In some implementations, the secondary node modification request message, the secondary node modification required message, the secondary node PSI-based discard procedure update notification message, the secondary node PSI-based discard procedure update notification required message, or any combination thereof, may include an information element or field that indicates the PSI-based discard procedure state request (e.g., a PSI-based discard procedure state request information element). The PSI-based discard procedure state request information element may include one or more bits where a first bit value (e.g., “0”) indicates that the first network entity 510-a (which may be a master node or secondary node) requests for the PSI-based discard procedure state to be deactivated, and a second bit value (e.g., “1”) indicates that the first network entity 510-a notifies as the PSI-based discard procedure state to be activated. For example, the information element may include the information illustrated in Table 3:

TABLE 3
PSI Based Discard Procedure State Request Information Element

| Presence | Range | Description |
|---|---|---|
| Optional | 0.1 | States that the master node or secondary node requests |
| | | for the PSI- Based Discard Procedure of the DRB ID: |
| | | 0 means ‘deactivated’ |
| | | 1 means ‘activated’ |

In some other implementations, the secondary node modification request message, the secondary node modification required message, the secondary node PSI-based discard procedure update notification message, the secondary node PSI-based discard procedure update notification required message, or any combination thereof, may include a PSI-based discard procedure MAC-CE request information element, which includes a MAC-CE (or an indication of the MAC-CE) that the first network entity 510-a requests to send to the UE 505. In some aspects, the MAC-CE request information element may indicate one or more formats of the MAC-CE that the first network entity 510-a may send to the UE 505.

At 535, the DU 515-b associated with the second network entity 510-b may output, via an F1 interface between the DU 515-b and the CU 520-b, the CU to DU PSI-based discard procedure update notification to the CU 520-b associated with the second network entity 510-b.

In some aspects, the first network entity 510-a, the second network entity 510-b, or both, may report an indication of a capability to support coordination before the PSI-based discard procedure state update. For example, the first network entity 510-a and the second network entity 510-b may each report the capability via one or more Xn-AP messages via the Xn interface. The one or more Xn-AP messages may include a secondary node addition request message, a secondary node addition request acknowledge message, a secondary node modification request message, a secondary node modification request acknowledge message, a secondary node modification required message, a secondary node modification confirm message, or any combination thereof. In such examples, the one or more Xn-AP messages may include an indication of the capability for the first network entity 510-a or the second network entity 510-b to support coordination before the PSI-based discard procedure state update.

In some other examples, the first network entity 510-a and the second network entity 510-b may each report the capability via one or more F1-AP messages via the F1 interface. The one or more F1-AP messages may include a UE context setup request message, a UE context setup response message, a UE context modification request message, a UE context modification response message, a UE context modification required message, a UE context modification confirm message, or any combination thereof. In such examples, the one or more F1-AP messages may include an indication of the capability for the first network entity 510-a or the second network entity 510-b to support coordination before the PSI-based discard procedure state update.

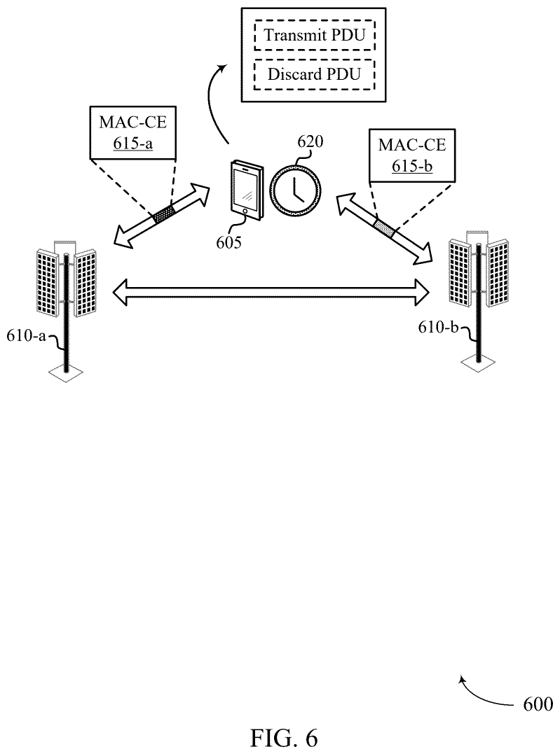

FIG. 6 shows an example of a wireless communications system 600 that supports PSI-based discard in dual connectivity in accordance with one or more aspects of the present disclosure. For example, the wireless communications system 600 may support communications between a UE 605 and one or more network entities (e.g., a first network entity 610-a and a second network entity 610-b), which may be examples of corresponding devices described herein. In some aspects, the UE 605 may support operating in a split bearer or dual connectivity deployment with both the first network entity 610-a and the second network entity 610-b.

The wireless communications system 600 may support dual connectivity, where the UE 605 may communicate data from a DRB to the first network entity 610-a (e.g., a master node) or the second network entity 610-b (e.g., a secondary node) via PDUs or PDU sets, and one or more PDUs may be included in a PDU set. In some aspects, different PDU sets may be associated with different discard timers 620 and an associated PDU discard procedure which may indicate to the UE 605 a duration for which to buffer PDUs before discarding the PDU based on the importance (or one or more importance metrics) of different PDUs being buffered. In such examples, the UE 605 may operate in accordance with a PSI-based discard procedure.

In some aspects, the first network entity 610-a, the second network entity 610-b, or both, may indicate one or more state changes for the PSI-based discard procedure, for example, whether the PSI-based discard procedure is activated or deactivated for one or more DRBs of the dual connectivity deployment. In some examples, the first network entity 610-a and the second network entity 610-b may coordinate the one or more state changes for the PSI-based discard procedure, and may notify the UE 605 via individual MAC-CEs or via a joint MAC-CE. For example, the first network entity 610-a may output a first MAC-CE 615-a that is indicative of an activation or deactivation of the PSI-based discard procedure, and the second network entity 610-b may output a second MAC-CE 615-b that is indicative of the activation or deactivation of the PSI-based discard procedure. Additionally, or alternatively, the first network entity 610-a or the second network entity 610-b may output a joint MAC-CE which is indicative of the activation or deactivation of the PSI-based discard procedure.

In some aspects, the behavior of the UE 605 may depend on the activation or deactivation MAC-CEs (e.g., the first MAC-CE 615-a, the second MAC-CE 615-b, or both) received from the first network entity 610-a and the second network entity 610-b. For example, the UE 605 may activate or deactivate the PSI-based discard procedure based on the received MAC-CEs, and may determine whether to transmit PDU sets whose shorter discard timer has expired in a cell group. The behavior of the UE 605 may be summarized in Table 4:

TABLE 4

| | | | | Transmission | |
|---|---|---|---|---|---|
| | | | | of UL PDU | |
| | | | | from DRB “i”-shorter | |
| | | | | discard timer | |
| Current | | | Current | has expired, | |
| PBDP | | | PBDP | longer discard | |
| State | Latest MAC-CE | | State | timer is active | |
| for DRB | From | From | for | Node 1 | Node 2 |
| “i” | Node 1 | Node 2 | DRB “i” | Cell Group | Cell Group |
| Activated | Activate | Activate | Activated | Forbidden | Forbidden |
| Activated | Activate | Deactivate | Activated | Forbidden | Allowed |
| Activated | Deactivate | Activate | Activated | Allowed | Allowed |
| Activated | De- | Deactivate | De- | Allowed | Allowed |
| | activated | | activated | | |
| Deactivated | Activate | Activate | Activated | Forbidden | Forbidden |
| Deactivated | Activate | Deactivate | Activated | Forbidden | Allowed |
| Deactivated | Deactivate | Activate | Activated | Allowed | Forbidden |
| Deactivated | Deactivate | Deactivate | De- | Allowed | Allowed |
| | | | activated | | |

For example, if the UE 605 determines that the current PSI-based discard procedure state for a DRB (e.g., DRB i) is active for both the first network entity 610-a (e.g., node 1) and the second network entity (e.g., node 2), and the latest MAC-CEs indicate an activation of the PSI-based discard procedure, the UE 605 may discard PDU sets for both network entities in the cell group (e.g., the UE may be “forbidden” from transmitting the PDU sets) when the shorter discard timer has expired and the longer discard timer is active. In some other examples, if the UE 605 determines that the current PSI-based discard procedure state for a DRB (e.g., DRB i) is active for the first network entity 610-a (e.g., node 1) and the second network entity (e.g., node 2), and determines that the latest received MAC-CEs activate the PSI-based discard procedure for the first network entity 610-a and deactivate the PSI-based discard procedure for the second network entity 610-b, the UE 605 may discard PDU sets for the first network entity 610-a in the cell group, and may transmit PDU sets for the second network entity 610-b in the cell group when the shorter discard timer has expired and the longer discard timer is active. In some other examples, if the UE 605 determines that the current PSI-based discard procedure state for a DRB (e.g., DRB i) is active for the first network entity 610-a (e.g., node 1) and the second network entity (e.g., node 2), and determines that the latest received MAC-CEs deactivate the PSI-based discard procedure for the first network entity 610-a and activate the PSI-based discard procedure for the second network entity 610-b, the UE 605 may transmit PDU sets for the first network entity 610-a in the cell group, and may discard PDU sets for the second network entity 610-b in the cell group when the shorter discard timer has expired and the longer discard timer is active. In some other examples, if the UE 605 determines that the current PSI-based discard procedure state for a DRB (e.g., DRB i) is active for the first network entity 610-a (e.g., node 1) and the second network entity (e.g., node 2), and determines that the latest received MAC-CEs deactivate the PSI-based discard procedure for the first network entity 610-a and deactivate the PSI-based discard procedure for the second network entity 610-b, the UE 605 may discard PDU sets for the first network entity 610-a and the second network entity 610-b in the cell group when the shorter discard timer has expired and the longer discard timer is active.

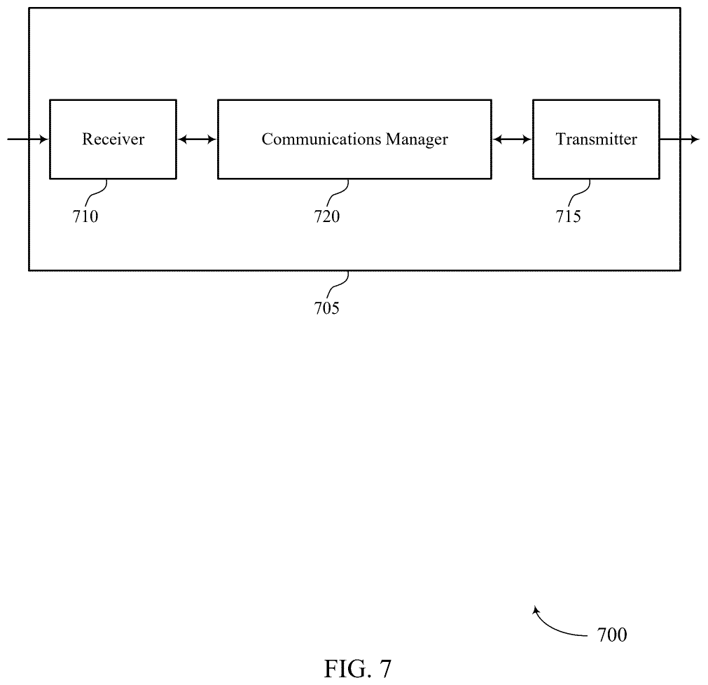

FIG. 7 shows a block diagram 700 of a device 705 that supports PSI-based discard in dual connectivity in accordance with one or more aspects of the present disclosure. The device 705 may be an example of aspects of a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, PDUs, SDUs) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, PDUs, SDUs) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations or components thereof may be examples of means for performing various aspects of PSI-based discard in dual connectivity as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for communicating with a UE via a split data radio bearer deployment that supports a PSI-based discard procedure for dual connectivity. The communications manager 720 is capable of, configured to, or operable to support a means for communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure. The communications manager 720 is capable of, configured to, or operable to support a means for communicating with the UE in accordance with the indication of the at least one state change of the PSI-based discard procedure.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, more efficient utilization of communication resources, reduced latency, improved device coordination, and reduced packet congestion.

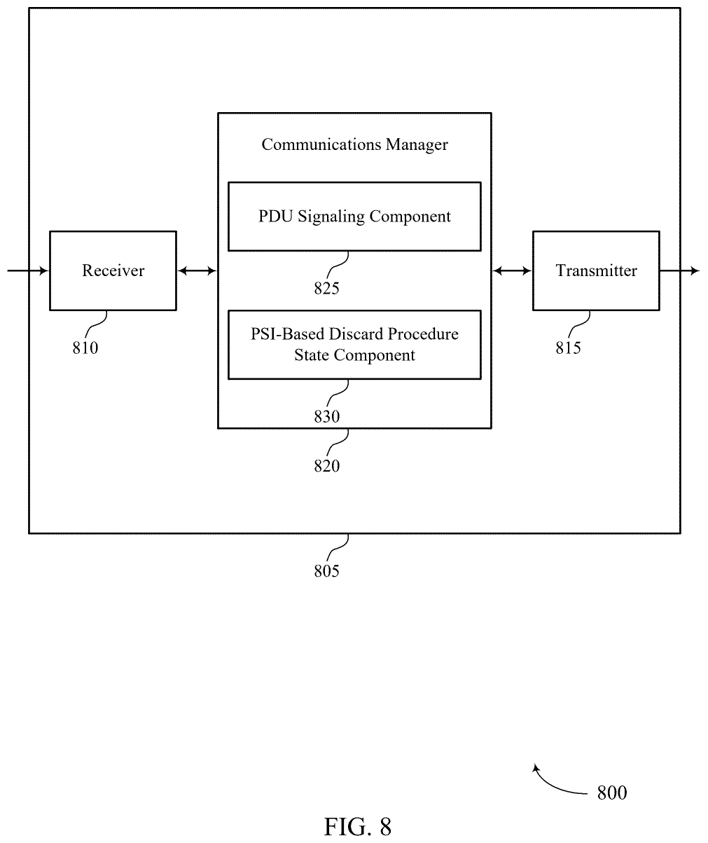

FIG. 8 shows a block diagram 800 of a device 805 that supports PSI-based discard in dual connectivity in accordance with one or more aspects of the present disclosure. The device 805 may be an example of aspects of a device 705 or a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, PDUs, SDUs) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, PDUs, SDUs) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of PSI-based discard in dual connectivity as described herein. For example, the communications manager 820 may include a PDU signaling component 825 a PSI-based discard procedure state component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The PDU signaling component 825 is capable of, configured to, or operable to support a means for communicating with a UE via a split data radio bearer deployment that supports a PSI-based discard procedure for dual connectivity. The PSI-based discard procedure state component 830 is capable of, configured to, or operable to support a means for communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure. The PDU signaling component 825 is capable of, configured to, or operable to support a means for communicating with the UE in accordance with the indication of the at least one state change of the PSI-based discard procedure.

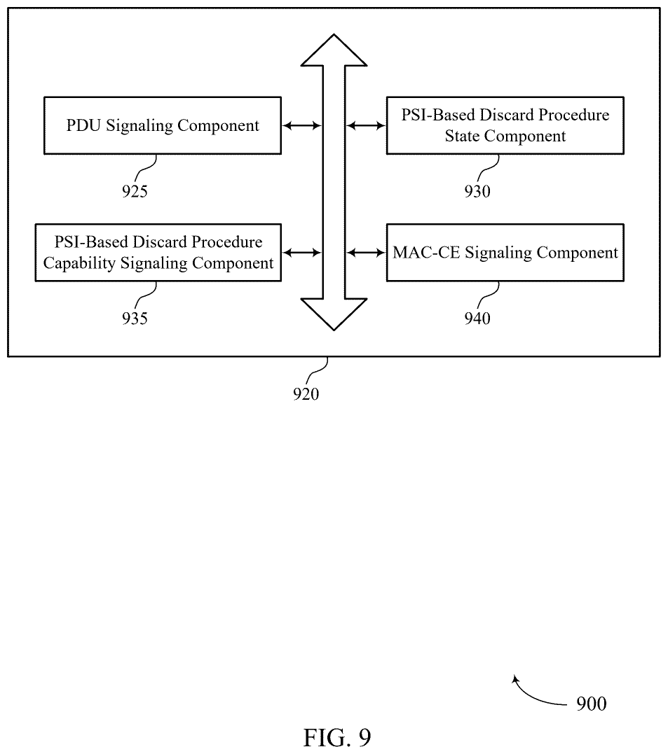

FIG. 9 shows a block diagram 900 of a communications manager 920 that supports PSI-based discard in dual connectivity in accordance with one or more aspects of the present disclosure. The communications manager 920 may be an example of aspects of a communications manager 720, a communications manager 820, or both, as described herein. The communications manager 920, or various components thereof, may be an example of means for performing various aspects of PSI-based discard in dual connectivity as described herein. For example, the communications manager 920 may include a PDU signaling component 925, a PSI-based discard procedure state component 930, a PSI-based discard procedure capability signaling component 935, a MAC-CE signaling component 940, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communications in accordance with examples as disclosed herein. The PDU signaling component 925 is capable of, configured to, or operable to support a means for communicating with a UE via a split data radio bearer deployment that supports a PSI-based discard procedure for dual connectivity. The PSI-based discard procedure state component 930 is capable of, configured to, or operable to support a means for communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure. In some examples, the PDU signaling component 925 is capable of, configured to, or operable to support a means for communicating with the UE in accordance with the indication of the at least one state change of the PSI-based discard procedure.

In some examples, the one or more messages further include a request for acceptance or rejection of the at least one state change of the PSI-based discard procedure, and the PSI-based discard procedure state component 930 is capable of, configured to, or operable to support a means for obtaining a first message indicating the acceptance or rejection of the at least one state change of the PSI-based discard procedure.

In some examples, the first network entity communicates the one or more messages that include the indication of the at least one state change of the PSI-based discard procedure prior to implementing the at least one state change of the PSI-based discard procedure.

In some examples, to support communicating the one or more messages, the PSI-based discard procedure state component 930 is capable of, configured to, or operable to support a means for communicating one or more PSI-based discard procedure update request messages and one or more PSI-based discard procedure update response messages via an Xn interface between a first centralized unit of the first network entity and a second centralized unit of the second network entity, where the one or more PSI-based discard procedure update request messages and the one or more PSI-based discard procedure update response messages are communicated via at least one of a secondary node modification request message, a secondary node modification required message, a secondary node modification request acknowledge message, or a secondary node modification confirm message.

In some examples, the secondary node modification request message, the secondary node modification required message, or both, include a PSI-based discard procedure state request information element for each data radio bearer of the split data radio bearer deployment.

In some examples, the PSI-based discard procedure is to be deactivated based on the PSI-based discard procedure state request information element having a first bit value, and the PSI-based discard procedure is to be activated based on the PSI-based discard procedure state request information element having a second bit value different from the first bit value.

In some examples, the secondary node modification request acknowledge message, the secondary node modification confirm message, or both, include a PSI-based discard procedure state response information element for each data radio bearer of the split data radio bearer deployment.

In some examples, the PSI-based discard procedure state response information element includes at least one response bit from a second network entity. In some examples, a first response bit value indicates that the at least one state change of the PSI-based discard procedure is denied, and a second response bit value different from the first response bit value indicates that the at least one state change of the PSI-based discard procedure is accepted.

In some examples, the PSI-based discard procedure state response information element includes at least one response bit from the second network entity. In some examples, a first response bit value indicates a request to implement a deactivation of the PSI-based discard procedure, and a second response bit value different from the first response bit value indicates a request to implement an activation of the PSI-based discard procedure.

In some examples, the secondary node modification request message, the secondary node modification required message, or both, include a PSI-based discard procedure MAC-CE request information element that is indicative of a MAC-CE that the first network entity requests to output to the UE.

In some examples, the secondary node modification request message, the secondary node modification confirm message, or both, include a PSI-based discard procedure MAC-CE response information element that is indicative of a MAC-CE that includes feedback information for the PSI-based discard procedure from a second network entity.

In some examples, to support communicating the one or more messages, the PSI-based discard procedure state component 930 is capable of, configured to, or operable to support a means for communicating one or more PSI-based discard procedure update request messages and one or more PSI-based discard procedure update response messages via an Xn interface between a first centralized unit of the first network entity and a second centralized unit of a second network entity, where the one or more PSI-based discard procedure update request messages and the one or more PSI-based discard procedure update response messages are communicated via at least one of a secondary node PSI-based discard procedure update request message, a secondary node PSI-based discard procedure update required message, a secondary node PSI-based discard procedure update request acknowledge message, or a secondary node PSI-based discard procedure update confirm message.

In some examples, the secondary node PSI-based discard procedure update request message, the secondary node PSI-based discard procedure update required message, or both, include a PSI-based discard procedure state request information element or in a PSI-based discard procedure MAC-CE request information element.

In some examples, the secondary node PSI-based discard procedure update request acknowledge message, the secondary node PSI-based discard procedure update confirm message, or both, include a PSI-based discard procedure state response information element or in a PSI-based discard procedure MAC-CE response information element.

In some examples, to support communicating the one or more messages, the PSI-based discard procedure state component 930 is capable of, configured to, or operable to support a means for communicating one or more PSI-based discard procedure update response messages via an Xn interface between a first centralized unit of the first network entity and a second centralized unit of a second network entity, where the one or more PSI-based discard procedure update response messages are communicated via a secondary node PSI-based discard procedure update request reject message, a secondary node PSI-based discard procedure update refuse message, or both.

In some examples, to support communicating the one or more messages, the PSI-based discard procedure state component 930 is capable of, configured to, or operable to support a means for communicating one or more PSI-based discard procedure update request messages and one or more PSI-based discard procedure update response messages via an F1 interface between a first distributed unit of the first network entity and a first centralized unit of the first network entity, where the one or more one or more PSI-based discard procedure update request messages and the one or more PSI-based discard procedure update response messages are communicated via at least one of a UE context modification request message, a UE context modification required message, a UE context modification response message, or a UE context modification confirm message.

In some examples, the UE context modification request message, the UE context modification required message, or both, include a PSI-based discard procedure state request information element for each data radio bearer of the split data radio bearer deployment.

In some examples, the PSI-based discard procedure is to be deactivated based on the PSI-based discard procedure state request information element having a first bit value, and the PSI-based discard procedure is to be activated based on the PSI-based discard procedure state request information element having a second bit value different from the first bit value.

In some examples, the UE context modification response message, the UE context modification confirm message, or both, include a PSI-based discard procedure state response information element for each data radio bearer of the split data radio bearer deployment.

In some examples, the PSI-based discard procedure state response information element includes at least one response bit. In some examples, a first response bit value indicates that the at least one state change of the PSI-based discard procedure is denied, and a second response bit value different from the first response bit value indicates that the at least one state change of the PSI-based discard procedure is accepted.

In some examples, the PSI-based discard procedure state response information element includes at least one response bit. In some examples, a first response bit value indicates a request to implement a deactivation of the PSI-based discard procedure, and a second response bit value different from the first response bit value indicates a request to implement an activation of the PSI-based discard procedure.

In some examples, the UE context modification request message, the UE context modification required message, or both, include a PSI-based discard procedure MAC-CE request information element that is indicative of a MAC-CE that the first network entity requests to output to the UE.

In some examples, the UE context modification response message, the UE context modification confirm message, or both, include a PSI-based discard procedure MAC-CE response information element that is indicative of a MAC-CE that includes feedback information for the PSI-based discard procedure from a second network entity.

In some examples, to support communicating the one or more messages, the PSI-based discard procedure state component 930 is capable of, configured to, or operable to support a means for communicating one or more PSI-based discard procedure update request messages and one or more PSI-based discard procedure update response messages via an F1 interface between a first distributed unit of the first network entity and a first centralized unit of the first network entity, where the one or more PSI-based discard procedure update request messages and the one or more PSI-based discard procedure update response messages are communicated via at least one of a UE PSI-based discard procedure update request message, a UE PSI-based discard procedure update required message, a UE PSI-based discard procedure update response message, or a UE PSI-based discard procedure update confirm message.

In some examples, the UE PSI-based discard procedure update request message, the UE PSI-based discard procedure update required message, or both, include a PSI-based discard procedure state request information element or in a PSI-based discard procedure MAC-CE request information element.

In some examples, the UE PSI-based discard procedure update response message, the UE PSI-based discard procedure update confirm message, or both, include a PSI-based discard procedure state response information element or in a PSI-based discard procedure MAC-CE response information element.

In some examples, to support communicating the one or more messages, the PSI-based discard procedure state component 930 is capable of, configured to, or operable to support a means for communicating one or more PSI-based discard procedure update response messages via an F1 interface between a first distributed unit of the first network entity and a first centralized unit of the first network entity, where the one or more PSI-based discard procedure update response messages are communicated via a UE PSI-based discard procedure update failure message, a UE PSI-based discard procedure update refuse message, or both.

In some examples, the PSI-based discard procedure capability signaling component 935 is capable of, configured to, or operable to support a means for communicating a capability message that indicates one or more capabilities of the first network entity, a second network entity, or both, to support coordination for the at least one state change of the PSI-based discard procedure prior to implementing the at least one state change of the PSI-based discard procedure.

In some examples, the capability message is communicated via an Xn interface via at least one of a secondary node addition request message, a secondary node addition request acknowledgment message, a secondary node modification request message, a secondary node modification request acknowledgment message, a secondary node modification required message, or a secondary node modification confirmation message.

In some examples, the capability message is communicated via an F1 interface via at least one of a UE context setup request message, a UE context setup response message, a UE context modification request message, a UE context modification response message, or a UE context modification required message, a UE context modification confirm message.

In some examples, the MAC-CE signaling component 940 is capable of, configured to, or operable to support a means for outputting a joint MAC-CE that is indicative of an activation or deactivation status of the at least one state change of the PSI-based discard procedure for the first network entity, a second network entity, or both.

In some examples, the joint MAC-CE includes a dual connectivity PSI-based discard procedure activation or deactivation MAC-CE.

In some examples, the joint MAC-CE includes two octets, a first octet including a first activation or deactivation status of the first network entity and a second octet including a second activation or deactivation status of a second network entity.

In some examples, to support communicating the one or more messages, the PSI-based discard procedure state component 930 is capable of, configured to, or operable to support a means for performing the at least one state change of the PSI-based discard procedure prior to communicating, with a second network entity, the one or more messages that include the indication of the at least one state change of the PSI-based discard procedure.

In some examples, the one or more messages are communicated via an Xn interface via a secondary node modification request message, a secondary node modification required message, or both.

In some examples, the secondary node modification request message, the secondary node modification required message, or both, include a PSI-based discard procedure state request information element or in a PSI-based discard procedure MAC-CE request information element.

In some examples, the one or more messages are communicated via an Xn interface via a secondary node PSI-based discard procedure update notification message, a secondary node PSI-based discard procedure update notification required message, or both.

In some examples, the secondary node PSI-based discard procedure update notification message, the secondary node PSI-based discard procedure update notification required message, or both, include a PSI-based discard procedure state request information element or in a PSI-based discard procedure MAC-CE request information element.

In some examples, the one or more messages are communicated via an F1 interface via a UE context modification request message, a UE context modification required message, or both.

In some examples, the UE context modification request message, the UE context modification required message, or both, include a PSI-based discard procedure state request information element or in a PSI-based discard procedure MAC-CE request information element.

In some examples, the one or more messages are communicated via an F1 interface via a UE PSI-based discard procedure update notification message, a UE PSI-based discard procedure update notification required message, or both.

In some examples, the UE PSI-based discard procedure update notification message, the UE PSI-based discard procedure update notification required message, or both, include a PSI-based discard procedure state request information element or in a PSI-based discard procedure MAC-CE request information element.

In some examples, the PSI-based discard procedure capability signaling component 935 is capable of, configured to, or operable to support a means for communicating a capability message that is indicative of one or more capabilities of the first network entity, a second network entity, or both, to support coordination for the at least one state change of the PSI-based discard procedure after implementing the at least one state change of the PSI-based discard procedure.

In some examples, the capability message is communicated via an Xn interface via at least one of a secondary node addition request message, a secondary node addition request acknowledgment message, a secondary node modification request message, a secondary node modification request acknowledgment message, a secondary node modification required message, or a secondary node modification confirmation message.

In some examples, the capability message is communicated via an F1 interface via at least one of a UE context setup request message, a UE context setup response message, a UE context modification request message, a UE context modification response message, a UE context modification required message, or a UE context modification confirm message.

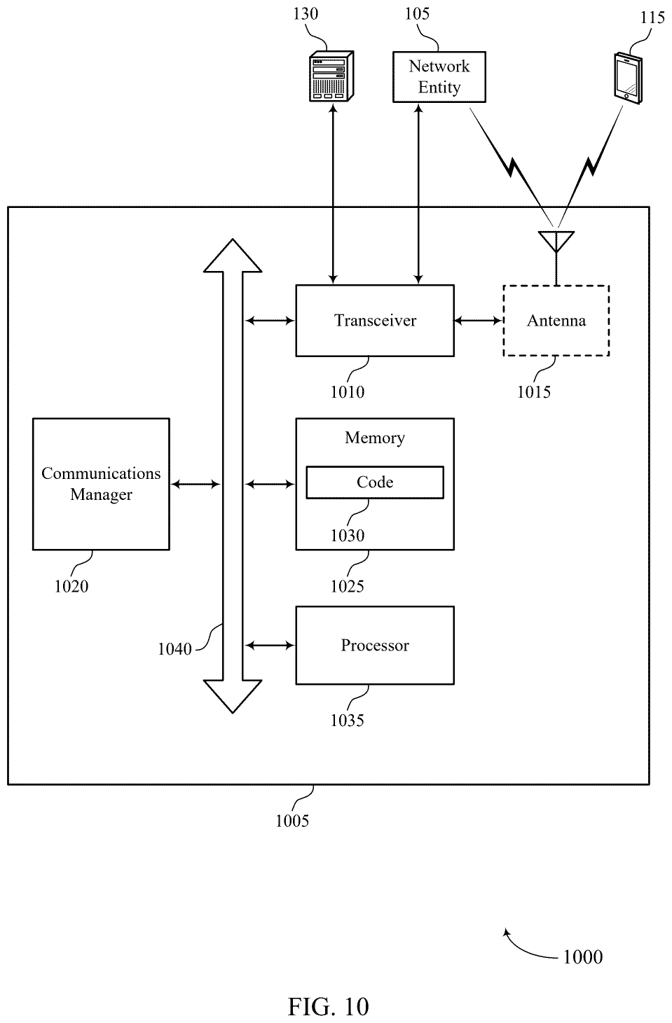

FIG. 10 shows a diagram of a system 1000 including a device 1005 that supports PSI-based discard in dual connectivity in accordance with one or more aspects of the present disclosure. The device 1005 may be an example of or include components of a device 705, a device 805, or a network entity 105 as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting PSI-based discard in dual connectivity). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for communicating with a UE via a split data radio bearer deployment that supports a PSI-based discard procedure for dual connectivity. The communications manager 1020 is capable of, configured to, or operable to support a means for communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure. The communications manager 1020 is capable of, configured to, or operable to support a means for communicating with the UE in accordance with the indication of the at least one state change of the PSI-based discard procedure.

By including or configuring the communications manager 1020 in accordance with examples as described herein, the device 1005 may support techniques for improved communication reliability, reduced latency, improved user experience related to reduced processing, more efficient utilization of communication resources, improved coordination between devices involved in dual connectivity, improved utilization of processing capability, and improved coordination for the activation and deactivation of PSI-based discard procedures.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of PSI-based discard in dual connectivity as described herein, or the at least one processor 1035 and the at least one memory 1025 may be otherwise configured to, individually or collectively, perform or support such operations.

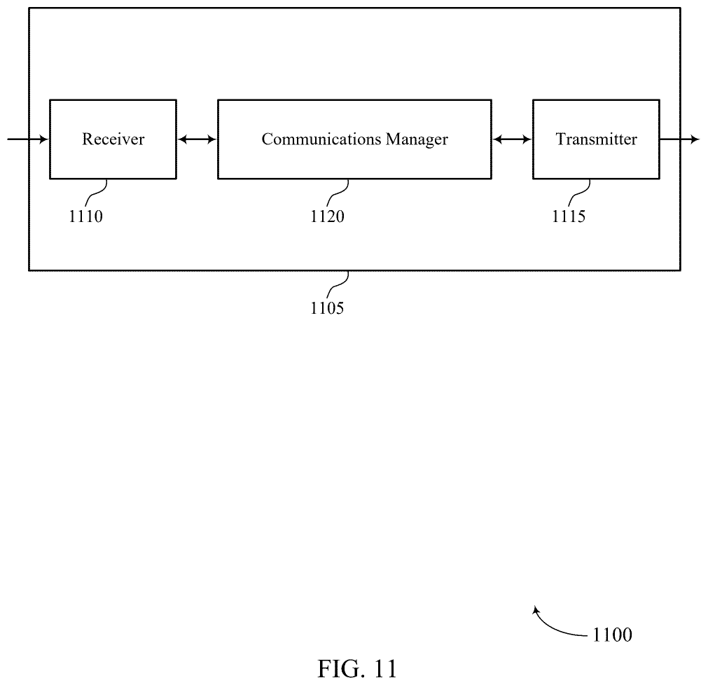

FIG. 11 shows a block diagram 1100 of a device 1105 that supports PSI-based discard in dual connectivity in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to PSI-based discard in dual connectivity). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to PSI-based discard in dual connectivity). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of PSI-based discard in dual connectivity as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for communicating with a first network entity and a second network entity in accordance with a split data radio bearer deployment that supports a PSI-based discard procedure for dual connectivity. The communications manager 1120 is capable of, configured to, or operable to support a means for receiving, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure. The communications manager 1120 is capable of, configured to, or operable to support a means for communicating with the first network entity and the second network entity in accordance with the at least one state change of the PSI-based discard procedure.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, more efficient utilization of communication resources, reduced latency, improved device coordination, and reduced packet congestion.

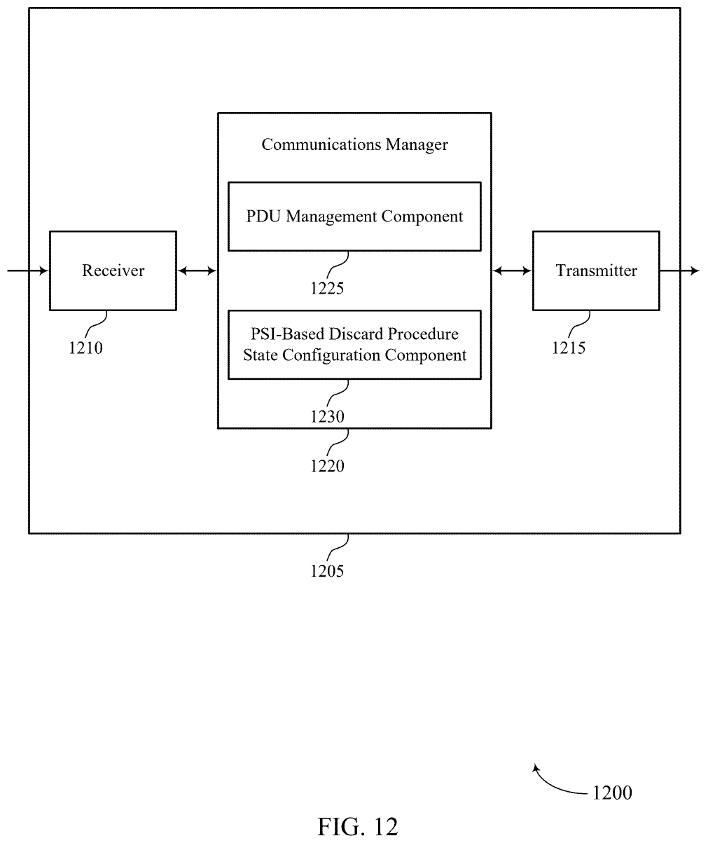

FIG. 12 shows a block diagram 1200 of a device 1205 that supports PSI-based discard in dual connectivity in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to PSI-based discard in dual connectivity). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to PSI-based discard in dual connectivity). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of PSI-based discard in dual connectivity as described herein. For example, the communications manager 1220 may include a PDU management component 1225 a PSI-based discard procedure state configuration component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The PDU management component 1225 is capable of, configured to, or operable to support a means for communicating with a first network entity and a second network entity in accordance with a split data radio bearer deployment that supports a PSI-based discard procedure for dual connectivity. The PSI-based discard procedure state configuration component 1230 is capable of, configured to, or operable to support a means for receiving, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure. The PDU management component 1225 is capable of, configured to, or operable to support a means for communicating with the first network entity and the second network entity in accordance with the at least one state change of the PSI-based discard procedure.

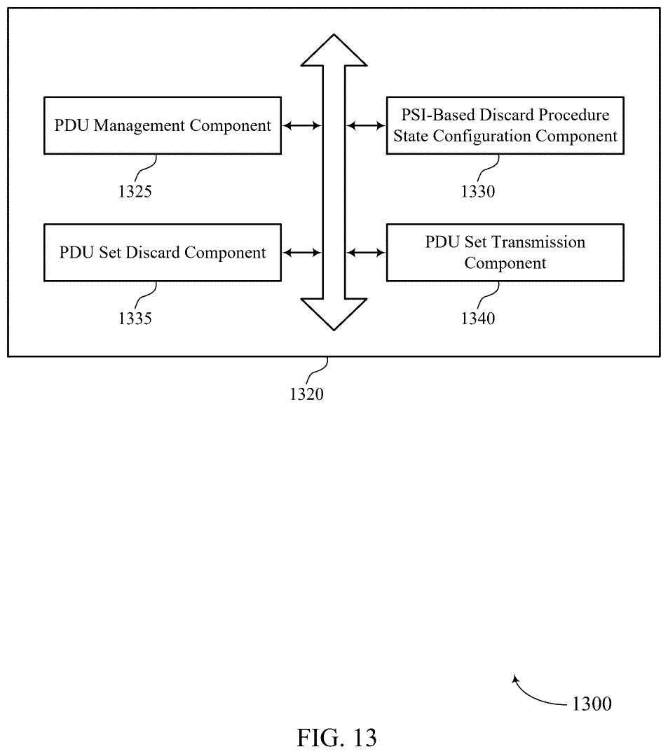

FIG. 13 shows a block diagram 1300 of a communications manager 1320 that supports PSI-based discard in dual connectivity in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of PSI-based discard in dual connectivity as described herein. For example, the communications manager 1320 may include a PDU management component 1325, a PSI-based discard procedure state configuration component 1330, a PDU set discard component 1335, a PDU set transmission component 1340, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The PDU management component 1325 is capable of, configured to, or operable to support a means for communicating with a first network entity and a second network entity in accordance with a split data radio bearer deployment that supports a PSI-based discard procedure for dual connectivity. The PSI-based discard procedure state configuration component 1330 is capable of, configured to, or operable to support a means for receiving, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure. In some examples, the PDU management component 1325 is capable of, configured to, or operable to support a means for communicating with the first network entity and the second network entity in accordance with the at least one state change of the PSI-based discard procedure.

In some examples, to support receiving the one or more respective messages, the PSI-based discard procedure state configuration component 1330 is capable of, configured to, or operable to support a means for receiving, from the first network entity, a first MAC-CE that indicates an activation or deactivation of the PSI-based discard procedure for the first network entity. In some examples, to support receiving the one or more respective messages, the PSI-based discard procedure state configuration component 1330 is capable of, configured to, or operable to support a means for receiving, from the second network entity, a second MAC-CE that indicates an activation or deactivation of the PSI-based discard procedure for the second network entity.

In some examples, the PDU set discard component 1335 is capable of, configured to, or operable to support a means for discarding a first PDU set associated with a first data radio bearer, where the first PDU set is discarded based on the first MAC-CE indicating the activation of the PSI-based discard procedure for the first network entity and an expiration of a first timer while a second timer is running. In some examples, the PDU set transmission component 1340 is capable of, configured to, or operable to support a means for transmitting, to the second network entity, a second PDU set associated with the first data radio bearer, where the second PDU set is transmitted based on the second MAC-CE indicating the deactivation of the PSI-based discard procedure for the second network entity and the expiration of the first timer while the second timer is running.

In some examples, the PDU set transmission component 1340 is capable of, configured to, or operable to support a means for transmitting, to the first network entity, a first PDU set associated with a first data radio bearer, where the first PDU set is transmitted based on the first MAC-CE indicating the deactivation of the PSI-based discard procedure for the first network entity and an expiration of a first timer while a second timer is running. In some examples, the PDU set discard component 1335 is capable of, configured to, or operable to support a means for discarding a second PDU set associated with the first data radio bearer, where the second PDU set is discarded based on the second MAC-CE indicating the activation of the PSI-based discard procedure for the second network entity and the expiration of the first timer while the second timer is running.

In some examples, the PDU set transmission component 1340 is capable of, configured to, or operable to support a means for transmitting, to the first network entity, a first PDU set associated with a first data radio bearer, where the first PDU set is transmitted based on the first MAC-CE indicating the deactivation of the PSI-based discard procedure for the first network entity and an expiration of a first timer while a second timer is running. In some examples, the PDU set transmission component 1340 is capable of, configured to, or operable to support a means for transmitting, to the second network entity, a second PDU set associated with the first data radio bearer, where the second PDU set is transmitted based on the second MAC-CE indicating the deactivation of the PSI-based discard procedure for the second network entity and the expiration of the first timer while the second timer is running.

In some examples, the PDU set discard component 1335 is capable of, configured to, or operable to support a means for discarding a first PDU set associated with a first data radio bearer, where the first PDU set is discarded based on the first MAC-CE indicating the activation of the PSI-based discard procedure for the first network entity and an expiration of a first timer while a second timer is running. In some examples, the PDU set discard component 1335 is capable of, configured to, or operable to support a means for discarding a second PDU set associated with the first data radio bearer, where the second PDU set is discarded based on the second MAC-CE indicating the activation of the PSI-based discard procedure for the second network entity and the expiration of the first timer while the second timer is running.

In some examples, the first MAC-CE and the second MAC-CE include at least one of PSI-based discard procedure activation MAC-CEs or PSI-based discard procedure deactivation MAC-CEs.

In some examples, the first MAC-CE and the second MAC-CE allow or disallow transmission of one or more SDUs that are associated with an expired discard timer for a cell group.

In some examples, to support receiving the one or more respective messages, the PSI-based discard procedure state configuration component 1330 is capable of, configured to, or operable to support a means for receiving, from the first network entity, the second network entity, or both, a joint MAC-CE that is indicative of an activation or deactivation status of the PSI-based discard procedure for the first network entity, the second network entity, or both.

In some examples, the joint MAC-CE includes two octets, a first octet including a first activation or deactivation status of the first network entity and a second octet including a second activation or deactivation status of the second network entity.

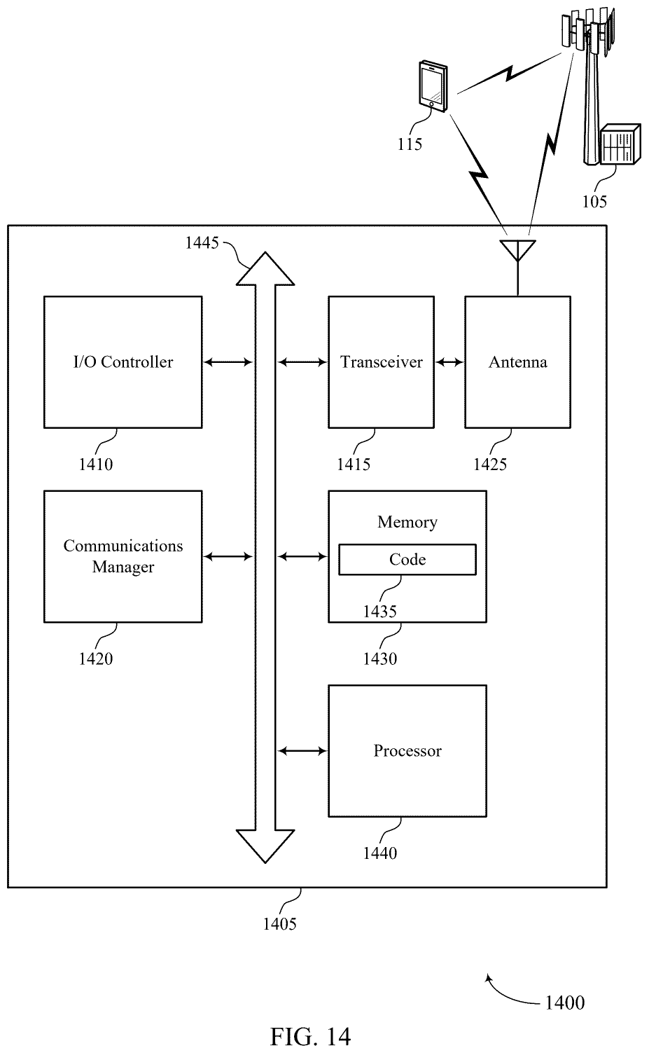

FIG. 14 shows a diagram of a system 1400 including a device 1405 that supports PSI-based discard in dual connectivity in accordance with one or more aspects of the present disclosure. The device 1405 may be an example of or include components of a device 1105, a device 1205, or a UE 115 as described herein. The device 1405 may communicate (e.g., wirelessly) with one or more other devices (e.g., network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting PSI-based discard in dual connectivity). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some examples, the at least one processor 1440 may include multiple processors and the at least one memory 1430 may include multiple memories. One or more of the multiple processors may be coupled with one or more of the multiple memories, which may, individually or collectively, be configured to perform various functions described herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (e.g., processor-executable code) stored in the at least one memory 1430 or otherwise, to perform one or more of the functions described herein.

The communications manager 1420 may support wireless communications in accordance with examples as disclosed herein. For example, the communications manager 1420 is capable of, configured to, or operable to support a means for communicating with a first network entity and a second network entity in accordance with a split data radio bearer deployment that supports a PSI-based discard procedure for dual connectivity. The communications manager 1420 is capable of, configured to, or operable to support a means for receiving, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure. The communications manager 1420 is capable of, configured to, or operable to support a means for communicating with the first network entity and the second network entity in accordance with the at least one state change of the PSI-based discard procedure.

By including or configuring the communications manager 1420 in accordance with examples as described herein, the device 1405 may support techniques for improved communication reliability, reduced latency, improved user experience related to reduced processing, more efficient utilization of communication resources, improved coordination between devices involved in dual connectivity, improved utilization of processing capability, and improved coordination for the activation and deactivation of PSI-based discard procedures.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of PSI-based discard in dual connectivity as described herein, or the at least one processor 1440 and the at least one memory 1430 may be otherwise configured to, individually or collectively, perform or support such operations.

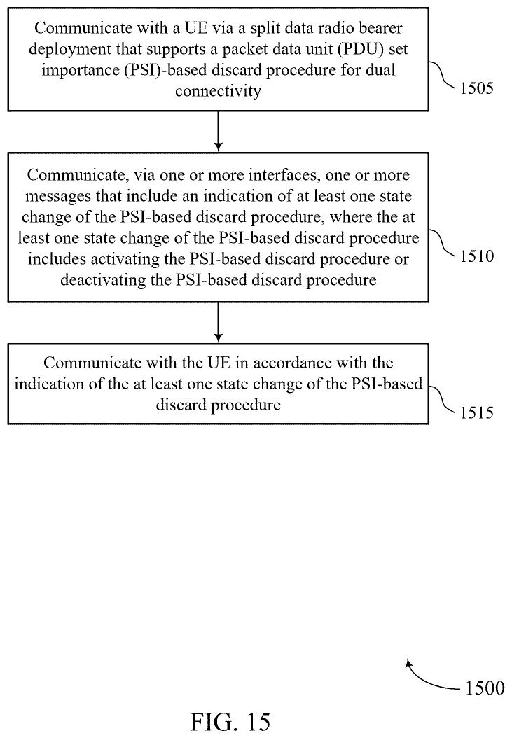

FIG. 15 shows a flowchart illustrating a method 1500 that supports PSI-based discard in dual connectivity in accordance with one or more aspects of the present disclosure. The operations of the method 1500 may be implemented by a network entity or its components as described herein. For example, the operations of the method 1500 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1505, the method may include communicating with a UE via a split data radio bearer deployment that supports a PSI-based discard procedure for dual connectivity. The operations of 1505 may be performed in accordance with examples as disclosed herein. In some examples, aspects of the operations of 1505 may be performed by a PDU signaling component 925 as described with reference to FIG. 9.

At 1510, the method may include communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure. The operations of 1510 may be performed in accordance with examples as disclosed herein. In some examples, aspects of the operations of 1510 may be performed by a PSI-based discard procedure state component 930 as described with reference to FIG. 9.

At 1515, the method may include communicating with the UE in accordance with the indication of the at least one state change of the PSI-based discard procedure. The operations of 1515 may be performed in accordance with examples as disclosed herein. In some examples, aspects of the operations of 1515 may be performed by a PDU signaling component 925 as described with reference to FIG. 9.

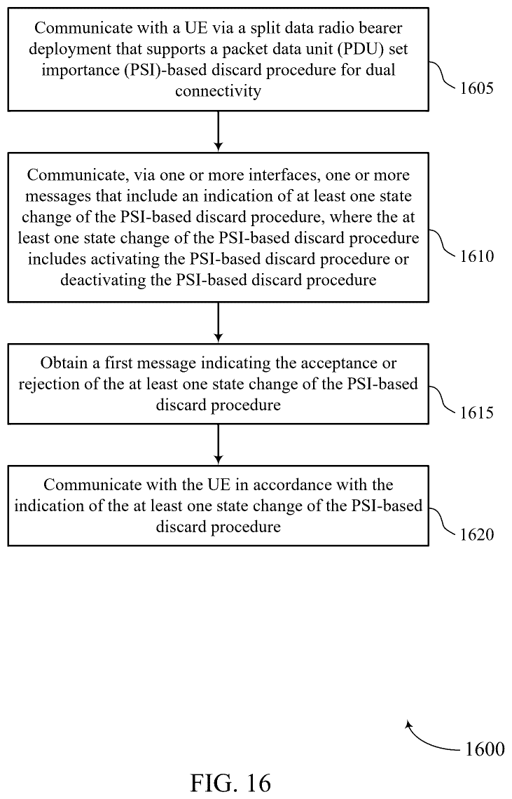

FIG. 16 shows a flowchart illustrating a method 1600 that supports PSI-based discard in dual connectivity in accordance with one or more aspects of the present disclosure. The operations of the method 1600 may be implemented by a network entity or its components as described herein. For example, the operations of the method 1600 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1605, the method may include communicating with a UE via a split data radio bearer deployment that supports a PSI-based discard procedure for dual connectivity. The operations of 1605 may be performed in accordance with examples as disclosed herein. In some examples, aspects of the operations of 1605 may be performed by a PDU signaling component 925 as described with reference to FIG. 9.

At 1610, the method may include communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure. The operations of 1610 may be performed in accordance with examples as disclosed herein. In some examples, aspects of the operations of 1610 may be performed by a PSI-based discard procedure state component 930 as described with reference to FIG. 9.

At 1615, the method may include obtaining a first message indicating the acceptance or rejection of the at least one state change of the PSI-based discard procedure. The operations of 1615 may be performed in accordance with examples as disclosed herein. In some examples, aspects of the operations of 1615 may be performed by a PSI-based discard procedure state component 930 as described with reference to FIG. 9.

At 1620, the method may include communicating with the UE in accordance with the indication of the at least one state change of the PSI-based discard procedure. The operations of 1620 may be performed in accordance with examples as disclosed herein. In some examples, aspects of the operations of 1620 may be performed by a PDU signaling component 925 as described with reference to FIG. 9.

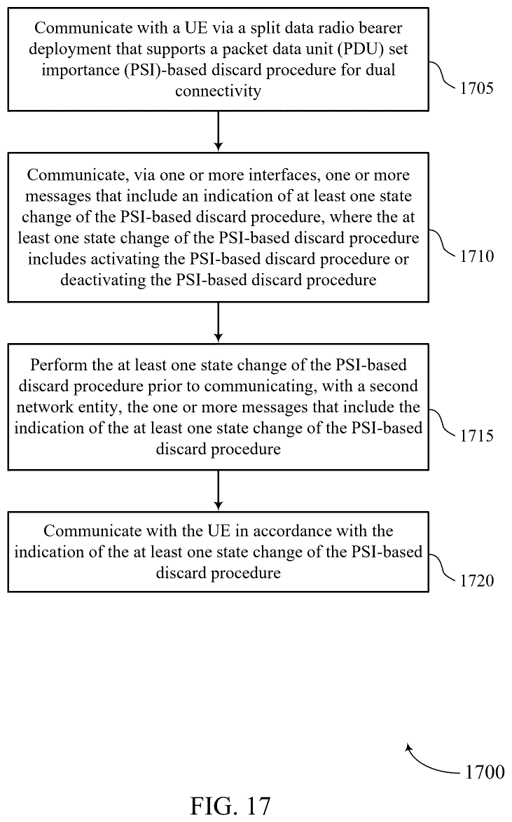

FIG. 17 shows a flowchart illustrating a method 1700 that supports PSI-based discard in dual connectivity in accordance with one or more aspects of the present disclosure. The operations of the method 1700 may be implemented by a network entity or its components as described herein. For example, the operations of the method 1700 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1705, the method may include communicating with a UE via a split data radio bearer deployment that supports a PSI-based discard procedure for dual connectivity. The operations of 1705 may be performed in accordance with examples as disclosed herein. In some examples, aspects of the operations of 1705 may be performed by a PDU signaling component 925 as described with reference to FIG. 9.

At 1710, the method may include communicating, via one or more interfaces, one or more messages that include an indication of at least one state change of the PSI-based discard procedure, where the at least one state change of the PSI-based discard procedure includes activating the PSI-based discard procedure or deactivating the PSI-based discard procedure. The operations of 1710 may be performed in accordance with examples as disclosed herein. In some examples, aspects of the operations of 1710 may be performed by a PSI-based discard procedure state component 930 as described with reference to FIG. 9.

At 1715, the method may include performing the at least one state change of the PSI-based discard procedure prior to communicating, with a second network entity, the one or more messages that include the indication of the at least one state change of the PSI-based discard procedure. The operations of 1715 may be performed in accordance with examples as disclosed herein. In some examples, aspects of the operations of 1715 may be performed by a PSI-based discard procedure state component 930 as described with reference to FIG. 9.

At 1720, the method may include communicating with the UE in accordance with the indication of the at least one state change of the PSI-based discard procedure. The operations of 1720 may be performed in accordance with examples as disclosed herein. In some examples, aspects of the operations of 1720 may be performed by a PDU signaling component 925 as described with reference to FIG. 9.

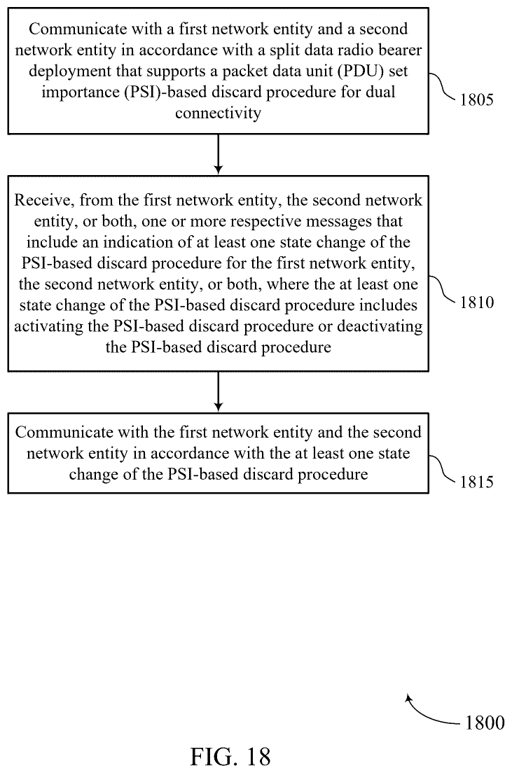

FIG. 18 shows a flowchart illustrating a method 1800 that supports PSI-based discard in dual connectivity in accordance with one or more aspects of the present disclosure. The operations of the method 1800 may be implemented by a UE or its components as described herein. For example, the operations of the method 1800 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1805, the method may include communicating with a first network entity and a second network entity in accordance with a split data radio bearer deployment that supports a PSI-based discard procedure for dual connectivity. The operations of 1805 may be performed in accordance with examples as disclosed herein. In some examples, aspects of the operations of 1805 may be performed by a PDU management component 1325 as described with reference to FIG. 13.

At 1810, the method may include receiving, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure. The operations of 1810 may be performed in accordance with examples as disclosed herein. In some examples, aspects of the operations of 1810 may be performed by a PSI-based discard procedure state configuration component 1330 as described with reference to FIG. 13.

At 1815, the method may include communicating with the first network entity and the second network entity in accordance with the at least one state change of the PSI-based discard procedure. The operations of 1815 may be performed in accordance with examples as disclosed herein. In some examples, aspects of the operations of 1815 may be performed by a PDU management component 1325 as described with reference to FIG. 13.

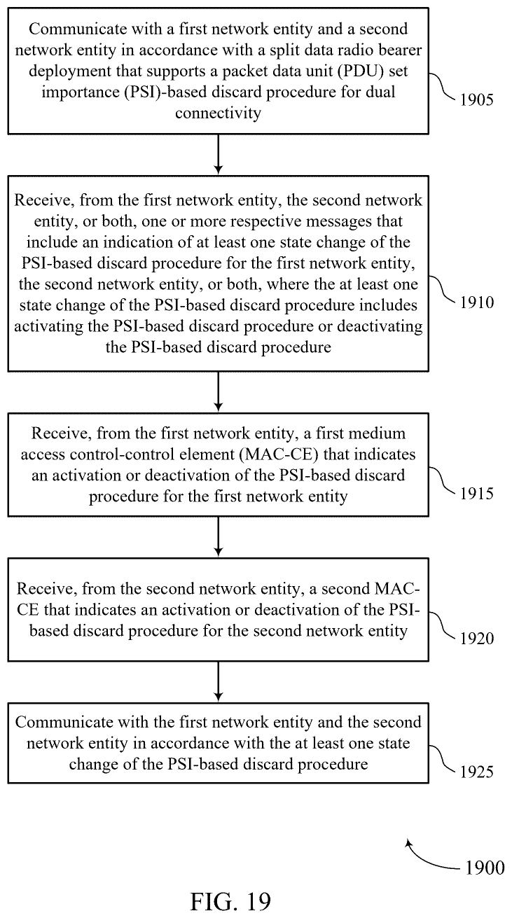

FIG. 19 shows a flowchart illustrating a method 1900 that supports PSI-based discard in dual connectivity in accordance with one or more aspects of the present disclosure. The operations of the method 1900 may be implemented by a UE or its components as described herein. For example, the operations of the method 1900 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1905, the method may include communicating with a first network entity and a second network entity in accordance with a split data radio bearer deployment that supports a PSI-based discard procedure for dual connectivity. The operations of 1905 may be performed in accordance with examples as disclosed herein. In some examples, aspects of the operations of 1905 may be performed by a PDU management component 1325 as described with reference to FIG. 13.

At 1910, the method may include receiving, from the first network entity, the second network entity, or both, one or more respective messages that include an indication of at least one state change of the PSI-based discard procedure for the first network entity, the second network entity, or both, where the at least one state change of the PSI-based discard procedure includes activating the PSI-based discard procedure or deactivating the PSI-based discard procedure. The operations of 1910 may be performed in accordance with examples as disclosed herein. In some examples, aspects of the operations of 1910 may be performed by a PSI-based discard procedure state configuration component 1330 as described with reference to FIG. 13.

At 1915, the method may include receiving, from the first network entity, a first MAC-CE that indicates an activation or deactivation of the PSI-based discard procedure for the first network entity. The operations of 1915 may be performed in accordance with examples as disclosed herein. In some examples, aspects of the operations of 1915 may be performed by a PSI-based discard procedure state configuration component 1330 as described with reference to FIG. 13.

At 1920, the method may include receiving, from the second network entity, a second MAC-CE that indicates an activation or deactivation of the PSI-based discard procedure for the second network entity. The operations of 1920 may be performed in accordance with examples as disclosed herein. In some examples, aspects of the operations of 1920 may be performed by a PSI-based discard procedure state configuration component 1330 as described with reference to FIG. 13.

At 1925, the method may include communicating with the first network entity and the second network entity in accordance with the at least one state change of the PSI-based discard procedure. The operations of 1925 may be performed in accordance with examples as disclosed herein. In some examples, aspects of the operations of 1925 may be performed by a PDU management component 1325 as described with reference to FIG. 13.

The following provides an overview of aspects of the present disclosure:

Aspect 1: A method for wireless communications at a first network entity, comprising: communicating with a UE via a split DRB deployment that supports a PSI-based discard procedure for dual connectivity; communicating, via one or more interfaces, one or more messages that include an indication of at least one state change of the PSI-based discard procedure, wherein the at least one state change of the PSI-based discard procedure comprises activating the PSI-based discard procedure or deactivating the PSI-based discard procedure; and communicating with the UE in accordance with the indication of the at least one state change of the PSI-based discard procedure.

Aspect 2: The method of aspect 1, wherein the one or more messages further include a request for acceptance or rejection of the at least one state change of the PSI-based discard procedure, the method further comprising: obtaining a first message indicating the acceptance or rejection of the at least one state change of the PSI-based discard procedure.

Aspect 3: The method of any of aspects 1 through 2, wherein the first network entity communicates the one or more messages that include the indication of the at least one state change of the PSI-based discard procedure prior to implementing the at least one state change of the PSI-based discard procedure.

Aspect 4: The method of any of aspects 1 through 3, wherein communicating the one or more messages comprises: communicating one or more PSI-based discard procedure update request messages and one or more PSI-based discard procedure update response messages via an Xn interface between a first CU of the first network entity and a second CU of the second network entity, wherein the one or more PSI-based discard procedure update request messages and the one or more PSI-based discard procedure update response messages are communicated via at least one of a secondary node modification request message, a secondary node modification required message, a secondary node modification request acknowledge message, or a secondary node modification confirm message.

Aspect 5: The method of aspect 4, wherein the secondary node modification request message, the secondary node modification required message, or both, comprise a PSI-based discard procedure state request information element for each DRB of the split DRB deployment.

Aspect 6: The method of aspect 5, wherein the PSI-based discard procedure is to be deactivated based at least in part on the PSI-based discard procedure state request information element having a first bit value, and the PSI-based discard procedure is to be activated based at least in part on the PSI-based discard procedure state request information element having a second bit value different from the first bit value.

Aspect 7: The method of any of aspects 4 through 6, wherein the secondary node modification request acknowledge message, the secondary node modification confirm message, or both, comprise a PSI-based discard procedure state response information element for each DRB of the split DRB deployment.

Aspect 8: The method of aspect 7, wherein the PSI-based discard procedure state response information element comprises at least one response bit from a second network entity, a first response bit value indicates that the at least one state change of the PSI-based discard procedure is denied, and a second response bit value different from the first response bit value indicates that the at least one state change of the PSI-based discard procedure is accepted.

Aspect 9: The method of any of aspects 7 through 8, wherein the PSI-based discard procedure state response information element comprises at least one response bit from the second network entity, a first response bit value indicates a request to implement a deactivation of the PSI-based discard procedure, and a second response bit value different from the first response bit value indicates a request to implement an activation of the PSI-based discard procedure.

Aspect 10: The method of any of aspects 4 through 9, wherein the secondary node modification request message, the secondary node modification required message, or both, comprise a PSI-based discard procedure MAC-CE request information element that is indicative of a MAC-CE that the first network entity requests to output to the UE.

Aspect 11: The method of any of aspects 4 through 10, wherein the secondary node modification request message, the secondary node modification confirm message, or both, comprise a PSI-based discard procedure MAC-CE response information element that is indicative of a MAC-CE that includes feedback information for the PSI-based discard procedure from a second network entity.

Aspect 12: The method of any of aspects 1 through 3, wherein communicating the one or more messages comprises: communicating one or more PSI-based discard procedure update request messages and one or more PSI-based discard procedure update response messages via an Xn interface between a first CU of the first network entity and a second CU of a second network entity, wherein the one or more PSI-based discard procedure update request messages and the one or more PSI-based discard procedure update response messages are communicated via at least one of a secondary node PSI-based discard procedure update request message, a secondary node PSI-based discard procedure update required message, a secondary node PSI-based discard procedure update request acknowledge message, or a secondary node PSI-based discard procedure update confirm message.

Aspect 13: The method of aspect 12, wherein the secondary node PSI-based discard procedure update request message, the secondary node PSI-based discard procedure update required message, or both, include a PSI-based discard procedure state request information element or in a PSI-based discard procedure MAC-CE request information element.

Aspect 14: The method of any of aspects 12 through 13, wherein the secondary node PSI-based discard procedure update request acknowledge message, the secondary node PSI-based discard procedure update confirm message, or both, include a PSI-based discard procedure state response information element or in a PSI-based discard procedure MAC-CE response information element.

Aspect 15: The method of any of aspects 1 through 3, wherein communicating the one or more messages comprises: communicating one or more PSI-based discard procedure update response messages via an Xn interface between a first CU of the first network entity and a second CU of a second network entity, wherein the one or more PSI-based discard procedure update response messages are communicated via a secondary node PSI-based discard procedure update request reject message, a secondary node PSI-based discard procedure update refuse message, or both.

Aspect 16: The method of any of aspects 1 through 3, wherein communicating the one or more messages comprises: communicating one or more PSI-based discard procedure update request messages and one or more PSI-based discard procedure update response messages via an F1 interface between a first DU of the first network entity and a first CU of the first network entity, wherein the one or more one or more PSI-based discard procedure update request messages and the one or more PSI-based discard procedure update response messages are communicated via at least one of a UE context modification request message, a UE context modification required message, a UE context modification response message, or a UE context modification confirm message.

Aspect 17: The method of aspect 16, wherein the UE context modification request message, the UE context modification required message, or both, comprise a PSI-based discard procedure state request information element for each DRB of the split DRB deployment.

Aspect 18: The method of aspect 17, wherein the PSI-based discard procedure is to be deactivated based at least in part on the PSI-based discard procedure state request information element having a first bit value, and the PSI-based discard procedure is to be activated based at least in part on the PSI-based discard procedure state request information element having a second bit value different from the first bit value.

Aspect 19: The method of any of aspects 16 through 18, wherein the UE context modification response message, the UE context modification confirm message, or both, comprise a PSI-based discard procedure state response information element for each DRB of the split DRB deployment.

Aspect 20: The method of aspect 19, wherein the PSI-based discard procedure state response information element comprises at least one response bit, a first response bit value indicates that the at least one state change of the PSI-based discard procedure is denied, and a second response bit value different from the first response bit value indicates that the at least one state change of the PSI-based discard procedure is accepted.

Aspect 21: The method of any of aspects 19 through 20, wherein the PSI-based discard procedure state response information element comprises at least one response bit, a first response bit value indicates a request to implement a deactivation of the PSI-based discard procedure, and a second response bit value different from the first response bit value indicates a request to implement an activation of the PSI-based discard procedure.

Aspect 22: The method of any of aspects 16 through 21, wherein the UE context modification request message, the UE context modification required message, or both, comprise a PSI-based discard procedure MAC-CE request information element that is indicative of a MAC-CE that the first network entity requests to output to the UE.

Aspect 23: The method of any of aspects 16 through 22, wherein the UE context modification response message, the UE context modification confirm message, or both, comprise a PSI-based discard procedure MAC-CE response information element that is indicative of a MAC-CE that includes feedback information for the PSI-based discard procedure from a second network entity.

Aspect 24: The method of any of aspects 1 through 3, wherein communicating the one or more messages comprises: communicating one or more PSI-based discard procedure update request messages and one or more PSI-based discard procedure update response messages via an F1 interface between a first DU of the first network entity and a first CU of the first network entity, wherein the one or more PSI-based discard procedure update request messages and the one or more PSI-based discard procedure update response messages are communicated via at least one of a UE PSI-based discard procedure update request message, a UE PSI-based discard procedure update required message, a UE PSI-based discard procedure update response message, or a UE PSI-based discard procedure update confirm message.

Aspect 25: The method of aspect 24, wherein the UE PSI-based discard procedure update request message, the UE PSI-based discard procedure update required message, or both, include a PSI-based discard procedure state request information element or in a PSI-based discard procedure MAC-CE request information element.

Aspect 26: The method of any of aspects 24 through 25, wherein the UE PSI-based discard procedure update response message, the UE PSI-based discard procedure update confirm message, or both, include a PSI-based discard procedure state response information element or in a PSI-based discard procedure MAC-CE response information element.

Aspect 27: The method of any of aspects 1 through 3, wherein communicating the one or more messages comprises: communicating one or more PSI-based discard procedure update response messages via an F1 interface between a first DU of the first network entity and a first CU of the first network entity, wherein the one or more PSI-based discard procedure update response messages are communicated via a UE PSI-based discard procedure update failure message, a UE PSI-based discard procedure update refuse message, or both.

Aspect 28: The method of any of aspects 1 through 27, further comprising: communicating a capability message that indicates one or more capabilities of the first network entity, a second network entity, or both, to support coordination for the at least one state change of the PSI-based discard procedure prior to implementing the at least one state change of the PSI-based discard procedure.

Aspect 29: The method of aspect 28, wherein the capability message is communicated via an Xn interface via at least one of a secondary node addition request message, a secondary node addition request acknowledgment message, a secondary node modification request message, a secondary node modification request acknowledgment message, a secondary node modification required message, or a secondary node modification confirmation message.

Aspect 30: The method of any of aspects 28 through 29, wherein the capability message is communicated via an F1 interface via at least one of a UE context setup request message, a UE context setup response message, a UE context modification request message, a UE context modification response message, or a UE context modification required message, a UE context modification confirm message.

Aspect 31: The method of any of aspects 1 through 30, further comprising: outputting a joint MAC-CE that is indicative of an activation or deactivation status of the at least one state change of the PSI-based discard procedure for the first network entity, a second network entity, or both.

Aspect 32: The method of aspect 31, wherein the joint MAC-CE comprises a dual connectivity PSI-based discard procedure activation or deactivation MAC-CE.

Aspect 33: The method of any of aspects 31 through 32, wherein the joint MAC-CE comprises two octets, a first octet including a first activation or deactivation status of the first network entity and a second octet including a second activation or deactivation status of a second network entity.

Aspect 34: The method of any of aspects 1 through 33, wherein communicating the one or more messages comprises: performing the at least one state change of the PSI-based discard procedure prior to communicating, with a second network entity, the one or more messages that include the indication of the at least one state change of the PSI-based discard procedure.

Aspect 35: The method of aspect 34, wherein the one or more messages are communicated via an Xn interface via a secondary node modification request message, a secondary node modification required message, or both.

Aspect 36: The method of aspect 35, wherein the secondary node modification request message, the secondary node modification required message, or both, include a PSI-based discard procedure state request information element or in a PSI-based discard procedure MAC-CE request information element.

Aspect 37: The method of any of aspects 34 through 36, wherein the one or more messages are communicated via an Xn interface via a secondary node PSI-based discard procedure update notification message, a secondary node PSI-based discard procedure update notification required message, or both.

Aspect 38: The method of claim of aspect 37, wherein the secondary node PSI-based discard procedure update notification message, the secondary node PSI-based discard procedure update notification required message, or both, include a PSI-based discard procedure state request information element or in a PSI-based discard procedure MAC-CE request information element.

Aspect 39: The method of any of aspects 34 through 38, wherein the one or more messages are communicated via an F1 interface via a UE context modification request message, a UE context modification required message, or both.

Aspect 40: The method of aspect 39, wherein the UE context modification request message, the UE context modification required message, or both, include a PSI-based discard procedure state request information element or in a PSI-based discard procedure MAC-CE request information element.

Aspect 41: The method of any of aspects 34 through 40, wherein the one or more messages are communicated via an F1 interface via a UE PSI-based discard procedure update notification message, a UE PSI-based discard procedure update notification required message, or both.

Aspect 42: The method of aspect 41, wherein the UE PSI-based discard procedure update notification message, the UE PSI-based discard procedure update notification required message, or both, include a PSI-based discard procedure state request information element or in a PSI-based discard procedure MAC-CE request information element.

Aspect 43: The method of any of aspects 34 through 42, further comprising: communicating a capability message that is indicative of one or more capabilities of the first network entity, a second network entity, or both, to support coordination for the at least one state change of the PSI-based discard procedure after implementing the at least one state change of the PSI-based discard procedure.

Aspect 44: The method of aspect 43, wherein the capability message is communicated via an Xn interface via at least one of a secondary node addition request message, a secondary node addition request acknowledgment message, a secondary node modification request message, a secondary node modification request acknowledgment message, a secondary node modification required message, or a secondary node modification confirmation message.

Aspect 45: The method of any of aspects 43 through 44, wherein the capability message is communicated via an F1 interface via at least one of a UE context setup request message, a UE context setup response message, a UE context modification request message, a UE context modification response message, a UE context modification required message, or a UE context modification confirm message.

Aspect 46: A method for wireless communications at a UE, comprising: communicating with a first network entity and a second network entity in accordance with a split DRB deployment that supports a PSI-based discard procedure for dual connectivity; receiving, from the first network entity, the second network entity, or both, one or more respective messages that include an indication of at least one state change of the PSI-based discard procedure for the first network entity, the second network entity, or both, wherein the at least one state change of the PSI-based discard procedure comprises activating the PSI-based discard procedure or deactivating the PSI-based discard procedure; and communicating with the first network entity and the second network entity in accordance with the at least one state change of the PSI-based discard procedure.

Aspect 47: The method of aspect 46, wherein receiving the one or more respective messages comprises: receiving, from the first network entity, a first MAC-CE that indicates an activation or deactivation of the PSI-based discard procedure for the first network entity; and receiving, from the second network entity, a second MAC-CE that indicates an activation or deactivation of the PSI-based discard procedure for the second network entity.

Aspect 48: The method of aspect 46, further comprising: discarding a first PDU set associated with a first DRB, wherein the first PDU set is discarded based at least in part on the first MAC-CE indicating the activation of the PSI-based discard procedure for the first network entity and an expiration of a first timer while a second timer is running; and transmitting, to the second network entity, a second PDU set associated with the first DRB, wherein the second PDU set is transmitted based at least in part on the second MAC-CE indicating the deactivation of the PSI-based discard procedure for the second network entity and the expiration of the first timer while the second timer is running.

Aspect 49: The method of aspect 46, further comprising: transmitting, to the first network entity, a first PDU set associated with a first DRB, wherein the first PDU set is transmitted based at least in part on the first MAC-CE indicating the deactivation of the PSI-based discard procedure for the first network entity and an expiration of a first timer while a second timer is running; and discarding a second PDU set associated with the first DRB, wherein the second PDU set is discarded based at least in part on the second MAC-CE indicating the activation of the PSI-based discard procedure for the second network entity and the expiration of the first timer while the second timer is running.

Aspect 50: The method of aspect 46, further comprising: transmitting, to the first network entity, a first PDU set associated with a first DRB, wherein the first PDU set is transmitted based at least in part on the first MAC-CE indicating the deactivation of the PSI-based discard procedure for the first network entity and an expiration of a first timer while a second timer is running; and transmitting, to the second network entity, a second PDU set associated with the first DRB, wherein the second PDU set is transmitted based at least in part on the second MAC-CE indicating the deactivation of the PSI-based discard procedure for the second network entity and the expiration of the first timer while the second timer is running.

Aspect 51: The method of aspect 46, further comprising: discarding a first PDU set associated with a first DRB, wherein the first PDU set is discarded based at least in part on the first MAC-CE indicating the activation of the PSI-based discard procedure for the first network entity and an expiration of a first timer while a second timer is running; and discarding a second PDU set associated with the first DRB, wherein the second PDU set is discarded based at least in part on the second MAC-CE indicating the activation of the PSI-based discard procedure for the second network entity and the expiration of the first timer while the second timer is running.

Aspect 52: The method of any of aspects 47 through 51, wherein the first MAC-CE and the second MAC-CE comprise at least one of PSI-based discard procedure activation MAC-CEs or PSI-based discard procedure deactivation MAC-CEs.

Aspect 53: The method of any of aspects 47 through 52, wherein the first MAC-CE and the second MAC-CE allow or disallow transmission of one or more SDUs that are associated with an expired discard timer for a cell group.

Aspect 54: The method of any of aspects 46 through 53, wherein receiving the one or more respective messages comprises: receiving, from the first network entity, the second network entity, or both, a joint MAC-CE that is indicative of an activation or deactivation status of the PSI-based discard procedure for the first network entity, the second network entity, or both.

Aspect 55: The method of aspect 54, wherein the joint MAC-CE comprises two octets, a first octet including a first activation or deactivation status of the first network entity and a second octet including a second activation or deactivation status of the second network entity.

Aspect 56: A first network entity for wireless communications, comprising one or more memories storing processor-executable code, and one or more processors coupled with the one or more memories and individually or collectively operable to execute the code to cause the first network entity to perform a method of any of aspects 1 through 45.

Aspect 57: A first network entity for wireless communications, comprising at least one means for performing a method of any of aspects 1 through 45.

Aspect 58: A non-transitory computer-readable medium storing code for wireless communications, the code comprising instructions executable by one or more processors to perform a method of any of aspects 1 through 45.

Aspect 59: A UE for wireless communications, comprising one or more memories storing processor-executable code, and one or more processors coupled with the one or more memories and individually or collectively operable to execute the code to cause the UE to perform a method of any of aspects 46 through 55.

Aspect 60: A UE for wireless communications, comprising at least one means for performing a method of any of aspects 46 through 55.

Aspect 61: A non-transitory computer-readable medium storing code for wireless communications, the code comprising instructions executable by one or more processors to perform a method of any of aspects 46 through 55.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate with a first network entity and a second network entity in accordance with a split data radio bearer deployment that supports a protocol data unit (PDU) set importance (PSI)-based discard procedure for dual connectivity;
receive, from the first network entity, the second network entity, or both, one or more respective messages that include an indication of at least one state change of the PSI-based discard procedure for the first network entity, the second network entity, or both,
wherein the at least one state change of the PSI-based discard procedure comprises an activation of the PSI-based discard procedure or a deactivation of the PSI-based discard procedure; and
communicate with the first network entity and the second network entity in accordance with the at least one state change of the PSI-based discard procedure.

2. The UE of claim 1, wherein, to receive the one or more respective messages, the one or more processors are individually or collectively operable to execute the code to cause the UE to:
receive, from the first network entity, a first medium access control-control element (MAC-CE) that indicates an activation or a deactivation of the PSI-based discard procedure for the first network entity; and
receive, from the second network entity, a second MAC-CE that indicates an activation or a deactivation of the PSI-based discard procedure for the second network entity.

3. The UE of claim 2, wherein the one or more processors are individually or collectively further operable to execute the code to cause the UE to:
discard a first PDU set associated with a first data radio bearer,
wherein the first PDU set is discarded based at least in part on the first MAC-CE indicating the activation of the PSI-based discard procedure for the first network entity and an expiration of a first timer while a second timer is running; and
transmit, to the second network entity, a second PDU set associated with the first data radio bearer,
wherein the second PDU set is transmitted based at least in part on the second MAC-CE indicating the deactivation of the PSI-based discard procedure for the second network entity and the expiration of the first timer while the second timer is running.

4. The UE of claim 2, wherein the one or more processors are individually or collectively further operable to execute the code to cause the UE to:
transmit, to the first network entity, a first PDU set associated with a first data radio bearer,
wherein the first PDU set is transmitted based at least in part on the first MAC-CE indicating the deactivation of the PSI-based discard procedure for the first network entity and an expiration of a first timer while a second timer is running; and
discard a second PDU set associated with the first data radio bearer,
wherein the second PDU set is discarded based at least in part on the second MAC-CE indicating the activation of the PSI-based discard procedure for the second network entity and the expiration of the first timer while the second timer is running.

5. The UE of claim 2, wherein the one or more processors are individually or collectively further operable to execute the code to cause the UE to:
transmit, to the first network entity, a first PDU set associated with a first data radio bearer,
wherein the first PDU set is transmitted based at least in part on the first MAC-CE indicating the deactivation of the PSI-based discard procedure for the first network entity and an expiration of a first timer while a second timer is running; and
transmit, to the second network entity, a second PDU set associated with the first data radio bearer,
wherein the second PDU set is transmitted based at least in part on the second MAC-CE indicating the deactivation of the PSI-based discard procedure for the second network entity and the expiration of the first timer while the second timer is running.

6. The UE of claim 2, wherein the one or more processors are individually or collectively further operable to execute the code to cause the UE to:
discard a first PDU set associated with a first data radio bearer,
wherein the first PDU set is discarded based at least in part on the first MAC-CE indicating the activation of the PSI-based discard procedure for the first network entity and an expiration of a first timer while a second timer is running; and
discard a second PDU set associated with the first data radio bearer,
wherein the second PDU set is discarded based at least in part on the second MAC-CE indicating the activation of the PSI-based discard procedure for the second network entity and the expiration of the first timer while the second timer is running.

7. The UE of claim 2, wherein:
the first MAC-CE and the second MAC-CE comprise at least one of PSI-based discard procedure activation MAC-CEs or PSI-based discard procedure deactivation MAC-CEs.

8. The UE of claim 2, wherein:
the first MAC-CE and the second MAC-CE allow or disallow transmission of one or more service data units that are associated with an expired discard timer for a cell group.

9. The UE of claim 1, wherein, to receive the one or more respective messages, the one or more processors are individually or collectively operable to execute the code to cause the UE to:
receive, from the first network entity, the second network entity, or both, a joint medium access control-control element (MAC-CE) that is indicative of an activation or deactivation status of the PSI-based discard procedure for the first network entity, the second network entity, or both.

10. The UE of claim 9, wherein:
the joint MAC-CE comprises two octets, a first octet including a first activation or deactivation status of the first network entity and a second octet including a second activation or deactivation status of the second network entity.

11. A first network entity, comprising:
one or more memories storing processor-executable code; and
one or more processors coupled with the one or more memories and individually or collectively operable to execute the code to cause the first network entity to:
communicate with a user equipment (UE) via a split data radio bearer deployment that supports a protocol data unit (PDU) set importance (PSI)-based discard procedure for dual connectivity;
communicate, via one or more interfaces, one or more messages that include an indication of at least one state change of the PSI-based discard procedure,
wherein the at least one state change of the PSI-based discard procedure comprises an activation of the PSI-based discard procedure or a deactivation of the PSI-based discard procedure; and
communicate with the UE in accordance with the indication of the at least one state change of the PSI-based discard procedure.

12. The first network entity of claim 11, wherein the one or more messages further include a request for acceptance or rejection of the at least one state change of the PSI-based discard procedure, and wherein the one or more processors are individually or collectively further operable to execute the code to cause the first network entity to:
obtain a first message indicating the acceptance or rejection of the at least one state change of the PSI-based discard procedure.

13. The first network entity of claim 11, wherein the first network entity communicates the one or more messages that include the indication of the at least one state change of the PSI-based discard procedure prior to an implementation of the at least one state change of the PSI-based discard procedure.

14. The first network entity of claim 11, wherein, to communicate the one or more messages, the one or more processors are individually or collectively operable to execute the code to cause the first network entity to:
communicate one or more PSI-based discard procedure update request messages and one or more PSI-based discard procedure update response messages via an Xn interface between a first centralized unit of the first network entity and a second centralized unit of a second network entity,
wherein the one or more PSI-based discard procedure update request messages and the one or more PSI-based discard procedure update response messages are communicated via at least one of a secondary node modification request message, a secondary node modification required message, a secondary node modification request acknowledge message, or a secondary node modification confirm message.

15. The first network entity of claim 11, wherein, to communicate the one or more messages, the one or more processors are individually or collectively operable to execute the code to cause the first network entity to:
communicate one or more PSI-based discard procedure update request messages and one or more PSI-based discard procedure update response messages via an Xn interface between a first centralized unit of the first network entity and a second centralized unit of a second network entity,
wherein the one or more PSI-based discard procedure update request messages and the one or more PSI-based discard procedure update response messages are communicated via at least one of a secondary node PSI-based discard procedure update request message, a secondary node PSI-based discard procedure update required message, a secondary node PSI-based discard procedure update request acknowledge message, or a secondary node PSI-based discard procedure update confirm message.

16. The first network entity of claim 11, wherein, to communicate the one or more messages, the one or more processors are individually or collectively operable to execute the code to cause the first network entity to:
communicate one or more PSI-based discard procedure update response messages via an Xn interface between a first centralized unit of the first network entity and a second centralized unit of a second network entity,
wherein the one or more PSI-based discard procedure update response messages are communicated via a secondary node PSI-based discard procedure update request reject message, a secondary node PSI-based discard procedure update refuse message, or both.

17. The first network entity of claim 11, wherein, to communicate the one or more messages, the one or more processors are individually or collectively operable to execute the code to cause the first network entity to:
communicate one or more PSI-based discard procedure update request messages and one or more PSI-based discard procedure update response messages via an F1 interface between a first distributed unit of the first network entity and a first centralized unit of the first network entity,
wherein the one or more one or more PSI-based discard procedure update request messages and the one or more PSI-based discard procedure update response messages are communicated via at least one of a UE context modification request message, a UE context modification required message, a UE context modification response message, or a UE context modification confirm message.

18. The first network entity of claim 11, wherein, to communicate the one or more messages, the one or more processors are individually or collectively operable to execute the code to cause the first network entity to:
communicate one or more PSI-based discard procedure update request messages and one or more PSI-based discard procedure update response messages via an F1 interface between a first distributed unit of the first network entity and a first centralized unit of the first network entity,
wherein the one or more PSI-based discard procedure update request messages and the one or more PSI-based discard procedure update response messages are communicated via at least one of a UE PSI-based discard procedure update request message, a UE PSI-based discard procedure update required message, a UE PSI-based discard procedure update response message, or a UE PSI-based discard procedure update confirm message.

19. The first network entity of claim 11, wherein, to communicate the one or more messages, the one or more processors are individually or collectively operable to execute the code to cause the first network entity to:
communicate one or more PSI-based discard procedure update response messages via an F1 interface between a first distributed unit of the first network entity and a first centralized unit of the first network entity,
wherein the one or more PSI-based discard procedure update response messages are communicated via a UE PSI-based discard procedure update failure message, a UE PSI-based discard procedure update refuse message, or both.

20. A method for wireless communications at a user equipment (UE), comprising:
communicating with a first network entity and a second network entity in accordance with a split data radio bearer deployment that supports a protocol data unit (PDU) set importance (PSI)-based discard procedure for dual connectivity;
receiving, from the first network entity, the second network entity, or both, one or more respective messages that include an indication of at least one state change of the PSI-based discard procedure for the first network entity, the second network entity, or both,
wherein the at least one state change of the PSI-based discard procedure comprises activating the PSI-based discard procedure or deactivating the PSI-based discard procedure; and
communicating with the first network entity and the second network entity in accordance with the at least one state change of the PSI-based discard procedure.
